(19) United States
(12) Patent Application Publication
(10) Pub. No.: US 2024/0293210 A1
(43) Pub. Date: Sep. 5, 2024

(54) ORAL CAVITY SUCTION DEVICE WITH LIGHTING

(71) Applicant: Hideyo UJI, Tokyo (JP)

(72) Inventor: Hideyo UJI, Tokyo (JP)

(21) Appl. No.: 17/637,721

(22) PCT Filed: Dec. 8, 2021
(86) PCT No.: PCT/JP2021/045106

§ 371 Date: Feb. 23, 2022

(30) Foreign Application Priority Data
Jan. 29, 2021 (WO) PCT/JP2021/004855
Oct. 20, 2021 (WO) PCT/JP2021/035218

(51) Int. Cl. A61C 17/06; A61C 17/08; A61C 17/12

(52) U.S. Cl. CPC A61C 17/084; A61C 17/08; A61C 17/12

(57) ABSTRACT

An oral cavity suction device comprising a vacuum hose and a vacuum tip including a tube body having a base end and a distal end that is a suction opening. The oral cavity suction device includes a hose-side light-outputting end face in the vacuum hose arranged to face the distal end side of the vacuum hose to output light input from a light source. The oral cavity suction device includes a light guiding element in the vacuum tip, with a tip-side light-receiving end face arranged to face the base end side of the vacuum tip to guide light input from the tip-side light-receiving end face and project the light. The hose-side light-outputting end face and the tip-side light-receiving end face allow light to be transmitted in a state in which the vacuum tip is completely connected to the vacuum hose.

### FIELD OF THE INVENTION

The present invention relates to an oral cavity suction device with a vacuum tip.

### BACKGROUND OF THE INVENTION

The oral cavity is one of important organs connecting to other organs. In a case where the oral cavity has, particularly at the base of the tongue, a tumor that is one of soft tissue diseases, even when general shadowless lighting is used, light does not easily reach the lesion in the oral cavity and thus it is very difficult to detect the lesion at an early stage. In a case where the oral cavity has a hard tissue disease, light of the shadowless lighting does not easily reach the root canal orifices of the distobuccal and mesiobuccal roots of the maxillary molars and thus it is difficult to clearly show the affected area. When a dentist puts a cutting handpiece or a mirror in a narrow space of the oral cavity or an assistant puts a suction vacuum tip in the narrow space of the oral cavity, a shadow is formed. Therefore, the shadowless lighting needs to illuminate the affected area from a distance while avoiding the cutting handpiece, the vacuum tip, or the like. As a result, every time the angle of the mouth of a patient slightly changes, it is necessary to adjust the angle of the conventional shadowless lighting.

In dental treatment, a suction device with a suction tool attached to the distal end of a vacuum hose is used to suction and eliminate any unnecessary substance from the oral cavity. Main distal-end suction tools are a saliva drainage tube (for example, Patent Literature 3) that suctions only liquid (saliva, blood, or water) and a vacuum tip (for example, Patent Literatures 1 and 2) that can suction both liquid and solid (such as a tooth, a metal fragment, and the like that have fallen into the oral cavity). A suction opening of the saliva drainage tube has a slit or a filter so as not to suction solid. The vacuum tip has a tube body with a diameter larger than that of the saliva drainage tube and the tube body has a large suction opening. In dental treatment, these two types of distal-end suction tools are used for different purposes as needed.

Patent Literature 2 discloses a dental suction mirror having a grip tube and an optical fiber fitted into the grip tube. Patent Literature 3 discloses a dental suction device having a lighting function provided by attaching an optical fiber to a saliva drainage tube.

Further, Patent Literature 4 discloses a device including a lighting function in a bite block, which is fixed in the oral cavity to stably protect the tongue of a patient in dental treatment. In Patent Literature 4, a light source is provided at a portion that is included in the device and is to be bitten by the patient.

Further, a light guide is known, which guides light from a light source, allows the light to be reflected and travel within the light guide, and projects the light from its side surface or its distal end for lighting of a road, a passage, or the like, lighting for photography, or the like (Patent Literature 5), although it is used in a technical field completely different from the dental field.

### CITATION LIST

### Patent Literatures

Patent Literature 1: Japanese Utility Model Laid-open Publication No. H7-17213

Patent Literature 2: Utility Model Registration Publication No. 3040304

Patent Literature 3: US Patent Specification No. 5931670

Patent Literature 4: Japanese Patent Application National Publication No. 2012-505702

Patent Literature 5: Japanese Patent Application National Publication No. 2012-522302

### SUMMARY OF THE INVENTION

In the dental suction device with lighting described in Patent Literature 3, a light emitting tip that also functions as a filter is attached to the suction opening at the distal end of the saliva drainage tube that can be bent and stretched. The optical fiber extends from a branch point in the middle of the saliva drainage tube to the distal end of the saliva drainage tube. At the branch point, the optical fiber on the saliva drainage tube is connected to another optical fiber extending from a light source. Light from the light source passes through the branch point and is transmitted by the optical fiber along the saliva drainage tube and scattered and projected by the light emitting tip. On the other hand, a flexible hose is connected to the base end of the saliva drainage tube and connected to a suction source.

The saliva drainage tube with lighting described in Patent Literature 3 has a problem that two operations are required to set the suction device. The first operation is to connect the saliva drainage tube to the distal end of the flexible hose to set the suction source. The second operation is to connect the optical fiber extending from the light source to the branch point in the middle of the saliva drainage tube to set the light source. Since many operations need to be performed for preparation before dental treatment, it is important to make the preparation operations as simple as possible.

Since the saliva drainage tube is usually used in a state in which the saliva drainage tube is in a U-shaped bent shape as described in Patent Literature 3, it is difficult to frequently move the saliva drainage tube up, down, left, and right in the oral cavity, compared to a vacuum tip. Therefore, when the saliva drainage tube is provided with lighting, it is not easy to move the saliva drainage tube freely and quickly to a target area in the oral cavity and illuminate the target area. This also applies to an intraoral device with lighting described in Patent Literature 4. Since the bite block described in Patent Literature 4 is used in a state in which the bite block is fixed in the oral cavity, the bite block cannot be moved freely.

In view of the above problems, an object of the present invention is to provide an oral cavity suction device that has a vacuum tip and a lighting function and that allows a setting operation to be efficiently performed before use.

In order to achieve the above object, the present invention includes the following configurations.

1) A first aspect of the present invention provides an oral cavity suction device including a vacuum hose connected to a suction source and a vacuum tip provided with a tube body having a base end insertable to a distal end of the vacuum hose and a distal end that is a suction opening, the oral cavity suction device comprising:
a hose-side light-outputting end face that is included in the vacuum hose and arranged to face a distal end side of the vacuum hose to output light from a light source; and
a light guiding element that is included in the vacuum tip, has a tip-side light-receiving end face arranged to face a base end side of the vacuum tip, and can guide light input from the tip-side light-receiving end face and project the light, wherein
the hose-side light-outputting end face and the tip-side light-receiving end face are positioned to allow light to be transmitted from the hose-side light-outputting end face to the tip-side light-receiving end face in a state in which the vacuum tip is completely connected to the vacuum hose.
   2) In the above aspect, the oral cavity suction device further comprises a light source fixed to an outer surface or an inner surface of the vacuum hose, wherein a light emitting face of the light source is the hose-side light-outputting end face.
   3) In the above aspect, the oral cavity suction device further comprises:
a light source fixed to an outer surface or an inner surface of the vacuum hose; and a hose-side optical fiber that has a base end connected to a light emitting face of the light source and is fixed to the vacuum hose, wherein
a distal end face of the hose-side optical fiber is the hose-side light-outputting end face.
   4) In the above aspect, the oral cavity suction device further comprises a hose-side optical fiber to which light from a light source is input and that extends in a hose wall of the vacuum hose or is attached to an outer surface or an inner surface of the vacuum hose and extends in a longitudinal direction and has a distal end face at or near the distal end of the vacuum hose, wherein
the distal end face of the hose-side optical fiber is the hose-side light-outputting end face.
   5) In the above aspect, the oral cavity suction device further comprises a tip-side optical fiber extending on an outer surface or an inner surface of a tube body of the vacuum tip or in a tube wall of the vacuum tip in a longitudinal direction, wherein
the tip-side optical fiber is the light guiding element, and
a base end face of the tip-side optical fiber is the tip-side light-receiving end face.
   6) In the above aspect, the tube body itself of the vacuum tip forms a light guide that can guide light in a longitudinal direction by fully reflecting the light,
the tube body itself of the vacuum tip is the light guiding element, and
a base end face of the tube body of the vacuum tip is the tip-side light-receiving end face.
   7) In the above aspect, the vacuum tip includes a tube body having a core portion extending in a tube wall in a longitudinal direction and a cladding portion forming a tube wall excluding the core portion, the core portion and the cladding portion are branched from an outer surface of the tube body at a position near a base end of the tube body and are continuous to a core and a cladding portion of an input optical fiber extending toward a base end side of the vacuum tip,
the tube body itself of the vacuum tip and the input optical fiber are the light guiding element, and
a free end of the input optical fiber is the tip-side light-receiving end face.
   8) In the above aspect, the core portion spirally extends in the tube wall with an axis of the tube body serving as a spiral axis.
   9) In the above aspect, the oral cavity suction device further comprises a tip-side optical fiber extending in a tube wall of the vacuum tip in a longitudinal direction, drawn from an outer surface of the tube body at a position near a base end of the tube body, and extending toward the base end side of the vacuum tip, wherein
the tip-side optical fiber is the light guiding element, and
a base end face of the tip-side optical fiber is the tip-side light-receiving end face.
   10) In the above aspect, the tube body itself of the vacuum tip forms a light guide that can guide light in a longitudinal direction by fully reflecting the light and a part of the light guide forms a branch portion branched from an outer surface of the tube body at a position near a base end of the tube body and extending toward a base end side of the vacuum tip,
the tube body itself of the vacuum tip and the branch portion are the light guiding element, and
a free end of the branch portion is the tip-side light-receiving end face.
   11) In the above aspect, an end of the vacuum tip and an end of the vacuum hose are attached to each other, one of the end of the vacuum tip and the end of the vacuum hose is a notch portion, and
the other of the end of the vacuum tip and the end of the vacuum hose is a locking protrusion, and when the vacuum tip is inserted in the vacuum hose, the vacuum tip is completely connected to the vacuum hose by moving the locking protrusion in the notch portion in a longitudinal direction and thereafter moving the locking protrusion in the notch portion in a circumferential direction at a joint portion of the vacuum tip and the vacuum hose.
   12) Another aspect of the present invention provides an oral cavity suction device with lighting, comprising:
an attachment including a tube body having a base end that can be inserted in a distal end of a vacuum hose connected to a suction source, and a distal end in which a base end of a vacuum tip can be inserted;
a light source fixed to an outer surface or an inner surface of a tube body of the attachment;
a light-outputting end face fixed to the outer surface or the inner surface of the tube body of the attachment and facing a distal end side of the attachment to output light from the light source;
a vacuum tip including a tube body having a base end that can be inserted in the distal end of the attachment and a distal end that is a suction opening; and
a light guiding element that is provided in the vacuum tip, has a light-receiving end face arranged to face a base end side of the vacuum tip, and can guide light input from the light-receiving end face and project the light, wherein
the light-outputting end face and the light-receiving end face are positioned to allow light to be transmitted from the light-outputting end face to the light-receiving end face in a state in which the vacuum tip is completely connected to the attachment.
   13) Still another aspect of the present invention provides an oral cavity suction device with lighting, comprising:
an attachment including a tube body having a base end that can be inserted in a distal end of a vacuum hose connected to a suction source, and a distal end in which a base end of a vacuum tip can be inserted;
an optical fiber having a base end connected to a light source, a distal end and a portion present near the distal end fixed to an outer surface or an inner surface of the tube body of the attachment, and a light-outputting end face that outputs light from the light source and arranged to face a distal end side of the attachment;
a vacuum tip including a tube body having a base end that can be inserted in the distal end of the attachment and a distal end that is a suction opening; and
a light guiding element that is provided in the vacuum tip, has a light-receiving end face arranged to face a base end side of the vacuum tip, and can guide light input from the light-receiving end face and project the light, wherein
the light-outputting end face and the light-receiving end face are positioned to allow light to be transmitted from the light-outputting end face to the light-receiving end face in a state in which the vacuum tip is completely connected to the attachment.

According to the present invention, in an oral cavity suction device in which a vacuum tip having a light guiding element is connected to a distal end of a vacuum hose, by performing a setting operation of a suction source in which the vacuum tip is connected to the vacuum hose, optical connection between the light guiding element of the vacuum tip and a light source can be automatically established at the same time. Therefore, it is not necessary to perform two operations of setting the suction source and the light source separately, and it is possible to efficiently perform an operation for preparation before treatment. The vacuum tip can be freely moved in the oral cavity as needed. Therefore, a target area in the oral cavity can be immediately illuminated using the vacuum tip with lighting.

### BRIEF DESCRIPTION OF THE DRAWINGS

FIG. 1 are schematic sectional views of an oral cavity suction device with lighting according to the present invention, where (a) illustrates a state in which a vacuum tip is connected to a vacuum hose, (b) illustrates a state in which the vacuum tip is disconnected from the vacuum hose, and (c) illustrates a modification thereof.

FIG. 2(a) is a schematic enlarged view of a region I illustrated in FIG. 1, (b) is a schematic sectional view taken along a line II-II illustrated in FIG. 1(a), and (c) is a schematic sectional view taken along a line III-III illustrated in FIG. 1(a).

FIG. 3 are schematic sectional views of an oral cavity suction device with lighting according to a second embodiment, where (a) illustrates a state in which a vacuum tip is connected to a vacuum hose, (b) illustrates a state in which the vacuum tip is disconnected from the vacuum hose, and (c) illustrates a light source unit according to another example.

FIG. 4(a) is a schematic enlarged view of a region IVa illustrated in FIG. 3(a), (b) is a schematic sectional view taken along a line Va-Va illustrated in FIG. 3(a), and (c) is a schematic enlarged view of a region VI illustrated in FIG. 3(a).

FIG. 5(a) is a schematic enlarged view of a region IVb illustrated in FIG. 3(a), (b) is a schematic sectional view taken along a line Vb-Vb illustrated in FIG. 3(a), (c) and (d) are schematic side views of a portion near a distal end of a vacuum tip in still another modification.

FIG. 6 are schematic sectional views of an oral cavity suction device with lighting according to a third embodiment, where (a) illustrates a state in which a vacuum tip is connected to a vacuum hose, and (b) illustrates a state in which the vacuum tip is disconnected from the vacuum hose.

FIG. 7(a) is a schematic enlarged view of a region VIIa illustrated in FIG. 6(a), (b) is a schematic enlarged view of a region VIIb illustrated in FIG. 6(a), and (c) is a schematic enlarged view of a region VIIc illustrated in FIG. 6(a).

FIG. 8(a) is a schematic sectional view taken along a line VIIIa-VIIIa illustrated in FIG. 6 and (b) is a schematic sectional view taken along a line VIIIb-VIIIb illustrated in FIG. 6(a).

FIG. 9 are schematic sectional views of an oral cavity suction device with lighting according to a fourth embodiment, where (a) illustrates a state in which a vacuum tip is connected to a vacuum hose and (b) illustrates a state in which the vacuum tip is disconnected from the vacuum hose.

FIG. 10 are schematic sectional views of a modification of the fourth embodiment, where (a) illustrates a state in which a vacuum tip is connected to a vacuum hose and (b) illustrates a state in which the vacuum tip is disconnected from the vacuum hose.

FIG. 11 illustrates a schematic section of an oral cavity suction device with lighting including an attachment according to an embodiment.

FIG. 12 illustrates a schematic section of an oral cavity suction device with lighting including an attachment according to another embodiment.

FIG. 13 are schematic side views of an oral cavity suction device with lighting provided with a locking mechanism according to an embodiment, where (a) illustrates a state before connection, (b) is a diagram of a vacuum tip as viewed in an IX direction, and (c) illustrates a state after completion of connection.

FIG. 14 illustrates another example of a combination of the vacuum hose and the vacuum tip in the embodiment in which a locking mechanism is provided.

FIG. 15 illustrate schematic side views of a connection portion of an attachment and a vacuum tip in the oral cavity suction device with lighting, where (a) illustrates a state before connection and (b) illustrates a state after completion of connection.

FIG. 16 illustrates another example of a combination of the attachment and the vacuum tip in the embodiment in which a locking mechanism is provided.

### DETAILED DESCRIPTION OF THE PREFERRED EMBODIMENTS

Embodiments of the present invention will be described below with reference to the drawings that illustrate exemplary embodiments. In the drawings, common or similar constituent elements among the embodiments are denoted by like or similar reference signs. In the descriptions of the respective embodiments, configurations that can be commonly applied to several embodiments are basically explained in the first embodiment, and explanations thereof may be omitted in other embodiments in some cases.

### (1) First Embodiment

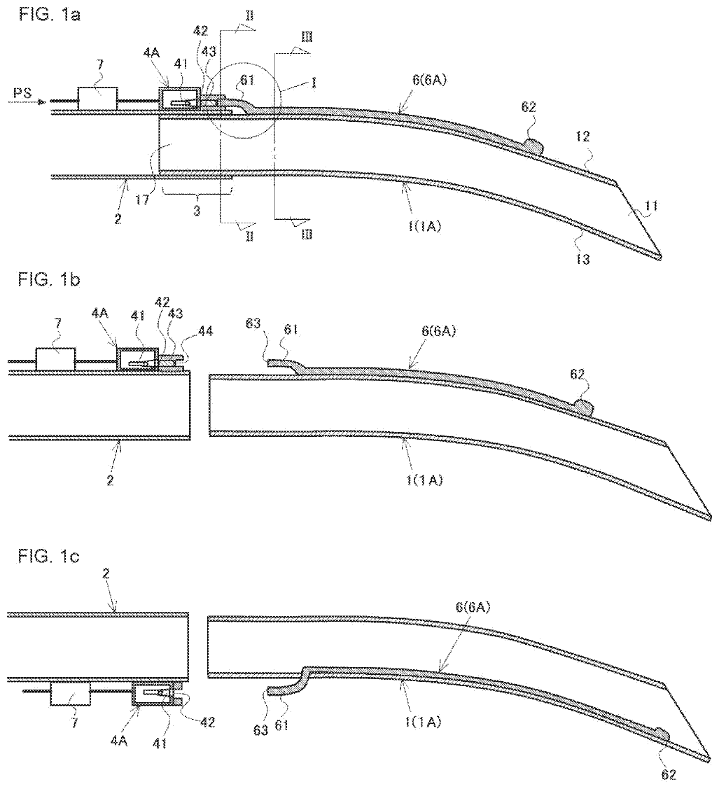

FIG. 1 are schematic sectional views of an oral cavity suction device with lighting according to a first embodiment, where (a) illustrates a state in which a vacuum tip 1 is connected to a vacuum hose 2 and (b) illustrates a state in which the vacuum tip 1 is disconnected from the vacuum hose 2. This cross section is a vertical cross section that appears when a set of the vacuum tip 1 and the vacuum hose 2 is divided approximately in half in their longitudinal directions (the same applies to similar drawings described later). Hereinafter, one end of the vacuum tip 1 on the side on which the vacuum tip 1 is connected to the vacuum hose 2 is referred to as “base end”, and the other end of the vacuum tip 1 on the opposite side is referred to as “distal end”. One end of the vacuum hose 2 on the suction source side is referred to as “base end”, and the other end of the vacuum hose 2 on the side on which the vacuum tip 1 is connected to the vacuum hose 2 is referred to as “distal end”. The same applies to “base ends” and “distal ends” of other members or elements attached to the vacuum tip 1 or the vacuum hose 2.

First, the basic mode of the oral cavity suction device according to the present invention is described except for a lighting function. The basic mode is known and is substantially common to each of the following embodiments. The oral cavity suction device includes a vacuum tip 1 having a hard tube body and a flexible vacuum hose 2. The base end of the vacuum hose 2 is connected to a suction source (not illustrated) such as an exhaust pump. The material of the vacuum tip is generally plastic such as polypropylene or metal, for example. The material of the vacuum hose 2 is soft vinyl chloride, silicone rubber, polyurethane resin, or the like, for example.

An insertion port 17 of the base end of the vacuum tip 1 can be inserted in the distal end of the vacuum hose 2. The insertion port 17 of the vacuum tip 1 is inserted in the vacuum hose 2 by only a predetermined length (for example, 1 to 2 centimeters (cm)). A joint portion 3 is an overlapping portion of the vacuum tip 1 and the vacuum hose 2. A stopper (not illustrated) such as a protrusion may be provided on the inner surface of the vacuum hose 2 to fix the length of the joint portion 3. By inserting the vacuum tip 1 in the vacuum hose 2, the inner space of the vacuum tip 1 and the inner space of the vacuum hose 2 communicate with each other. The vacuum tip 1 has a suction opening 11 at the distal end thereof. An operator holds a portion of the vacuum tip 1 in the vicinity of the base end thereof by hand and moves the vacuum tip 1 in the oral cavity to perform necessary suctioning.

In the illustrated example, the tube body of the vacuum tip 1 extends from the base end to the distal end and is at least partially bent. The length of the vacuum tip 1 from the base end to the distal end is approximately 10 to 15 cm, for example. In another example, the tube body of the vacuum tip 1 may be curved entirely, or may extend linearly, or may be bent at an angle of 90° or an obtuse angle in the middle of the tube body. A sectional shape of the tube body orthogonal to the longitudinal direction of the tube body is normally a substantially circular shape or a substantially elliptical shape.

In the illustrated example, the suction opening 11 has a shape obtained by cutting a distal end portion of the tube body diagonally with respect to the longitudinal direction. Since the vacuum tip 1 is usually used such that the suction opening 11 faces a suction target object, a protruding curved surface of the vacuum tip 1 on the side facing the suction opening 11 is an operation-side surface 12 and a recessed curved surface of the vacuum tip 1 on the opposite side is a non-operation-side surface 13. In another example, a rubber tip may be attached to the suction opening 11. The vacuum tip 1 suctions both solid and liquid in the oral cavity. Therefore, when it is assumed that solid is suctioned, the opening area of the suction opening 11 is preferably large. The suction opening 11 may have a gradually increasing opening area like a trumpet. As an example, the inner diameters of the insertion port 17 and the suction opening 11 of the vacuum tip 1 are approximately 8 to 20 millimeters (mm).

In the oral cavity suction device according to the present invention, the vacuum tip 1 has a lighting function of illuminating the inside of the oral cavity. In this case, the surroundings of the operation-side surface 12 and/or the suction opening 11 are preferably illuminated. However, the illumination range is not limited thereto and the surroundings of the vacuum tip 1 including the non-operation-side surface 13 may be entirely illuminated. Therefore, the oral cavity suction device according to the present invention has at least the following configurations.

The oral cavity suction device has a hose-side light-outputting end face provided in the vacuum hose 2 and facing the distal end side of the vacuum hose 2 to output light from a light source.

The oral cavity suction device has a light guiding element 6 provided in the vacuum tip 1 and having a tip-side light-receiving end face facing the base end side of the vacuum tip 1.

The hose-side light-outputting end face and the tip-side light-receiving end face are positioned to allow light to be transmitted from the hose-side light-outputting end face to the tip-side light-receiving end face in a state in which the vacuum tip 1 is completely connected to the vacuum hose 2.

In some embodiments of the present invention described later, the hose-side light-outputting end face is, for example, a light emitting face of the light source or a distal end face of an optical fiber connected to the light source. The light guiding element 6 can guide light input from the tip-side light-receiving end face toward the distal end side of the vacuum tip 1 and project the light from a side surface of the light guiding element 6 and/or a distal end of the light guiding element 6. The light guiding element 6 may be provided on an outer surface or an inner surface of the tube body of the vacuum tip 1 or in a tube wall of the tube body. Alternatively, the light guiding element 6 may be constituted by the tube body itself of the vacuum tip 1.

In addition, the end faces that “allow light to be transmitted from the hose-side light-outputting end face to the tip-side light-receiving end face” are preferably positioned such that the hose-side light-outputting end face and the tip-side light-receiving end face are opposed to each other and are in contact with each other without a gap. However, the term “contact” is used in a broader sense in the present specification. In a state in which the end faces are in a contact state such that most (for example, 90% or more) of light output from the hose-side light-outputting end face can pass through the tip-side light-receiving end face, even when a small gap is present between the two end faces, the two faces are regarded as being in “contact” with each other.

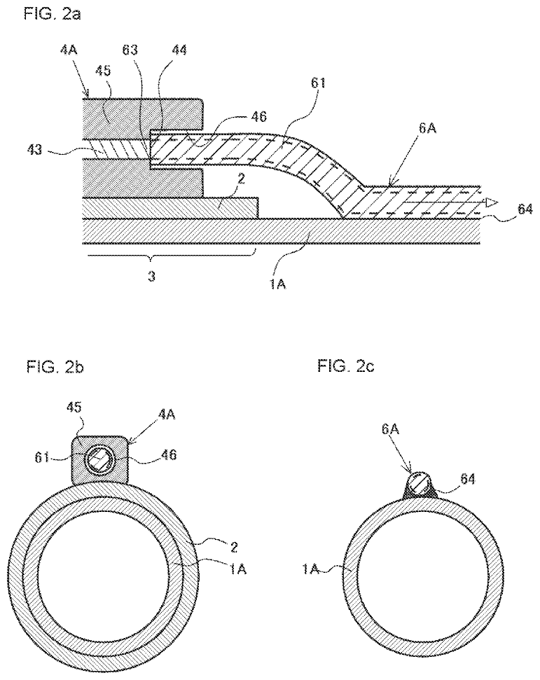

Next, a lighting function of the oral cavity suction device according to the first embodiment is described with reference to FIGS. 1 and 2. FIG. 2(a) is a schematic enlarged view of a region I illustrated in FIG. 1(a), (b) is a schematic sectional view taken along a line II-II illustrated in FIG. 1(a), and (c) is a schematic sectional view taken along a line III-III illustrated in FIG. 1(a). FIG. 2(a) schematically illustrates an approximate traveling direction of most of light using a white arrow (the same applies to similar drawings described later).

As illustrated in FIG. 1(a), a light source unit 4A is attached to the outer surface of the vacuum hose 2 in the vicinity of the distal end of the vacuum hose 2. The light source unit 4A includes an appropriate housing fixed to the outer surface of the vacuum hose 2 and a light source device 41 accommodated in the housing. The light source device 41 is, for example, a light emitting diode (LED), a halogen lamp, or the like. The light source device 41 is configured to emit light toward the distal end side of the vacuum hose 2. In the illustrated example, a light emitting face 42 is exposed on a side surface of the housing facing the distal end side of the vacuum hose 2. A base end of a hose-side optical fiber 43 is connected at the light emitting face 42. Light emitted from the light source device 41 enters the hose-side optical fiber 43.

As illustrated in FIG. 2(a), for example, the hose-side optical fiber 43 is formed integrally with the housing of the light source unit 4A and supported by a support portion 45 having a through-hole. Therefore, a distal end face 44 of the hose-side optical fiber 43 is fixed and faces the distal end side of the vacuum hose 2. The distal end face 44 is orthogonal to the axis of a cylindrical joint portion 3 illustrated in FIG. 1(a). In the first embodiment, the distal end face 44 of the hose-side optical fiber 43 is a hose-side light-outputting end face. This relatively short hose-side optical fiber 43 is not an essential element and has a role in adjusting the position of the hose-side light-outputting end face in the axis direction.

As an example, a control unit 7 is attached to the outer surface of the vacuum hose 2 in the vicinity of the light source unit 4A. The control unit 7 is connected to a power supply (not illustrated) such as a commercial power supply or a storage battery via a conductive line and power is supplied from the power supply to the control unit 7. The control unit 7 is electrically connected to the light source unit 4A and can supply power to the light source device 41. The control unit 7 has a switch that turns on and off at least the power supply. Although not illustrated in the drawings, an operation unit of the switch is provided on an outer surface of a housing of the control unit 7, for example. The control unit 7 may have a function of adjusting the intensity of lighting. In this case, an operation unit that adjusts the intensity is provided on the outer surface of the housing. An operator operates the switch or the like to turn on and off the lighting function and adjust the intensity of the lighting.

In the illustrated example, the light source unit 4A is separated from the control unit 7. However, in another example, the light source unit 4A and the control unit 7 may be provided in one housing. Although not illustrated in the drawings, as still another example, when the power supply is a small battery or a rechargeable battery, the power supply can be accommodated in the control unit 7. In still another example, the control unit 7 may not be attached to the vacuum hose 2 and may be provided outside the oral cavity suction device. For example, a constituent element of the control unit 7 can be included in an operational panel of a dental unit.

Next, a vacuum tip 1A is described. In the drawings, regarding the vacuum tip, sign 1 indicates a vacuum tip as a high-level concept, and 1A, 1B, and the like obtained by adding capital letters to sign 1 indicate vacuum tips according to each embodiment. In addition, regarding the light guiding element, sign 6 indicates the light guiding element as a high-level concept, and 6A, 6B, and the like obtained by adding capital letters to sign 6 indicate light guiding elements according to each embodiment. The term “light guiding element” is used as a high-level concept that means a member that can transmit light.

A tip-side optical fiber 6A is attached to an outer surface of a tube body of the vacuum tip 1A and extends in the longitudinal direction (a broken line schematically indicates a boundary between a core of the optical fiber and a cladding of the optical fiber. The same applies to the following drawings). In the first embodiment, the tip-side optical fiber 6A is a light guiding element of the vacuum tip 1A. In this case, a light guiding function is not required for the tube body of the vacuum tip 1A and thus the tube body may be made of a non-transparent material, for example, a material used for general vacuum tips. The tip-side optical fiber 6A is preferably attached to the operation-side surface 12. As illustrated in FIG. 2(c), the tip-side optical fiber 6A is fixed to the outer surface of the vacuum tip 1A by, for example, a fixing member 64 such as an adhesive.

A light outputting portion 62 of the distal end of the tip-side optical fiber 6A is positioned near the suction opening 11 as an example. The position of the light outputting portion 62 is not limited to the position illustrated in the drawing. The light outputting portion 62 may be positioned closer to the suction opening 11 or may be farther from the suction opening 11. The light outputting portion 62 may be provided with a member that scatters or disperses light. In still another example, since the optical fiber can emit light from its side surface, the tip-side optical fiber 6A can project light from its side surface, instead of or in addition to the light outputting portion 62 of the distal end. In this case, for example, the tip-side optical fiber 6A can emit light from only its portion present near the distal end of the tip-side optical fiber 6A, or from half of the tip-side optical fiber 6A on the distal end side, or from the entire tip-side optical fiber 6A.

A light receiving portion 61 of the tip-side optical fiber 6A that is present near the base end of the tip-side optical fiber 6A slightly protrudes from the outer surface of the vacuum tip 1A, is separated from the outer surface of the vacuum tip 1A, and extends toward the base end side of the vacuum tip 1A. The light receiving portion 61 of the tip-side optical fiber 6A protrudes for alignment with the hose-side optical fiber 43. A base end face 63 of the tip-side optical fiber 6A faces the base end side of the vacuum tip 1A. The base end face 63 is orthogonal to the axis of a cylindrical joint portion 3 illustrated in FIG. 1(a). In the first embodiment, the base end face 63 of the tip-side optical fiber 6A is a tip-side light-receiving end face. Although not illustrated in the drawings, the light receiving portion 61 may be surrounded and sealed by a member made of hard resin or the like to fix and protect the light receiving portion 61.

As illustrated in FIGS. 2(a) and (b), as an example, a recess 46 is formed at the distal end of the support portion 45 formed in the housing of the light source unit 4A. The base end of the tip-side optical fiber 6A can be inserted in the recess 46. Therefore, in a state in which the vacuum tip 1A is inserted in the vacuum hose 2, the light receiving portion 61 of the tip-side optical fiber 6A can be more stably supported. The recess 46 is effective for positioning and support but is not essential.

In the illustrated example, the single light source unit 4A and the single tip-side optical fiber 6A are provided. However, in another example, the light source unit 4A may be provided in plural, the tip-side optical fiber 6A may be provided in plural, the light source units 4A are arranged at a predetermined interval in the circumferential direction on the outer surface of the vacuum hose 2, and the tip-side optical fibers 6A corresponding to the light source units 4A are arranged at a predetermined interval in the circumferential direction on the outer surface of the vacuum tip 1. In this case, power can be supplied from the single control unit 7 to the plurality of light source units 4A.

In the oral cavity suction device illustrated in FIG. 1, when the vacuum tip 1A and the vacuum hose 2 are changed from a detached state illustrated in FIG. 1(b) to an inserted state illustrated in FIG. 1(a), that is, in a state in which the vacuum tip 1A is completely connected to the vacuum hose 2, the distal end face 44 of the hose-side optical fiber 43 that is a hose-side light-outputting end face and the base end face 63 of the tip-side optical fiber 6A that is a tip-side light-receiving end face are opposed to each other and can be in contact with each other in a state in which light can be transmitted. The insertion operation is performed basically by moving the vacuum tip 1A in the axial direction of the joint portion 3. In order to obtain this contact state, the position of the hose-side light-outputting end face of the vacuum hose 2 and the position of the tip-side light-receiving end face of the vacuum tip 1 are set. A contact face of the hose-side light-outputting end face and the tip-side light-receiving end face may not be orthogonal to the axial direction of the joint portion 3 and may be inclined with respect to the axial direction of the joint portion 3. Alternatively, when one of the hose-side light-outputting end face and the tip-side light-receiving end face is a protruding face and the other of the hose-side light-outputting end face and the tip-side light-receiving end face is a recessed face, the contact face is a curved face.

The hose-side light-outputting end face (the distal end face 44) and the tip-side light-receiving end face (the base end face 63) are optimally in contact with each other such that all of light output from the hose-side light-outputting end face passes through the tip-side light-receiving end face. Therefore, it is preferable that the position of the hose-side light-outputting end face and the position of the tip-side light-receiving end face be set such that the entire region of the hose-side light-outputting end face is included in the region of the tip-side light-receiving end face as viewed from the axis direction of the joint portion 3. This applies to the following other embodiments.

FIG. 1(c) illustrates a modification of the first embodiment. In the vacuum tip 1A illustrated in FIG. 1(c), the tip-side optical fiber 6A that is a light guiding element is attached to an inner surface of a tube body. This inner surface corresponds to the back side of the non-operation-side surface 13. The light outputting portion 62 of the distal end of the tip-side optical fiber 6A is positioned near the suction opening 11 and allows the surroundings of the suction opening 11 to be illuminated from the inner side. The light receiving portion 61 of the tip-side optical fiber 6A that is present near the base end of the tip-side optical fiber 6A penetrates the tube body of the vacuum tip 1A, is drawn toward the outer side, slightly protrudes from the outer surface, is separated from the outer surface, and extends toward the base end side of the vacuum tip 1A. The base end face 63 of the tip-side optical fiber 6A is a tip-side light-receiving end face.

FIG. 1(c) also illustrates a modification of the light source unit 4A provided on the vacuum hose 2. The light source unit 4A fixed to the outer surface of the vacuum hose 2 in the vicinity of the distal end of the vacuum hose 2 is not provided with the hose-side optical fiber 43 illustrated in FIG. 1(a), and the light emitting face 42 of the light source device 41 is a hose-side light-outputting end face.

Although not illustrated in the drawings, the light receiving portion 61 of the tip-side optical fiber 6A may not be arranged on the outer side of the tube body and may extend to the base end face of the vacuum tip 1A along the inner surface of the tube body in the example illustrated in FIG. 1(c). In this case, each of vacuum hoses according to some embodiments described later can be combined with the vacuum tip 1A. In each of the vacuum hoses that can be combined, a hose-side light-outputting end face is provided.

### (2) Second Embodiment and Modifications Thereof

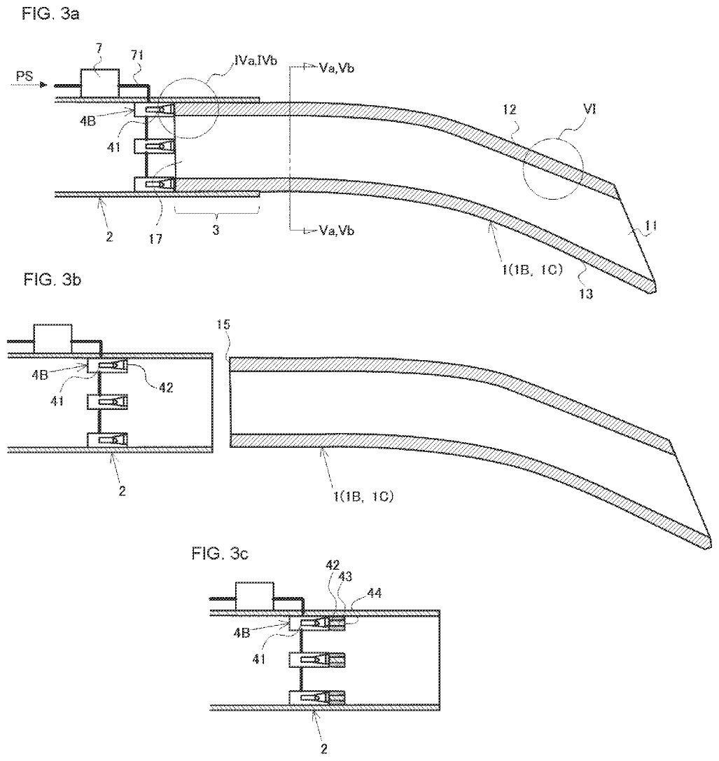

An oral cavity suction device according to a second embodiment of the present invention and modifications thereof are described with reference to FIGS. 3, 4, and 5.

FIG. 3 are schematic sectional views of the oral cavity suction device with lighting according to the second embodiment, where (a) illustrates a state in which the vacuum tip 1 is connected to the vacuum hose 2, (b) illustrates a state in which the vacuum tip 1 is disconnected from the vacuum hose 2, and (c) illustrates a light source unit 4B according to another example.

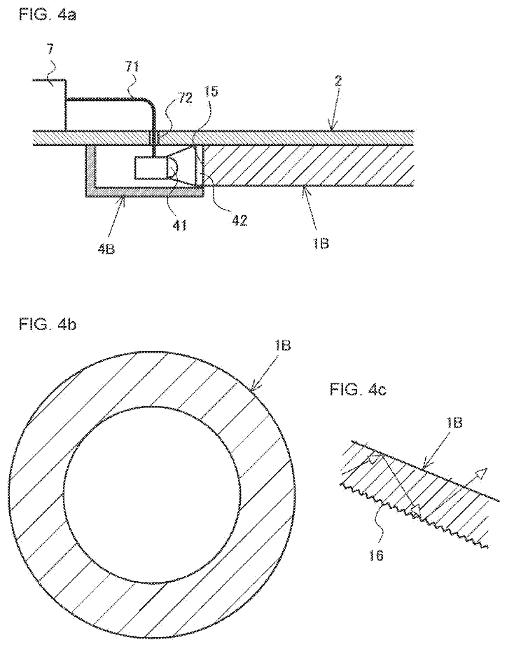

FIG. 4(a) is a schematic enlarged view of a region IVa illustrated in FIG. 3(a), (b) is a schematic sectional view taken along a line light Va-Va illustrated in FIG. 3(a), and (c) is a schematic enlarged view of a region VI illustrated in FIG. 3(a).

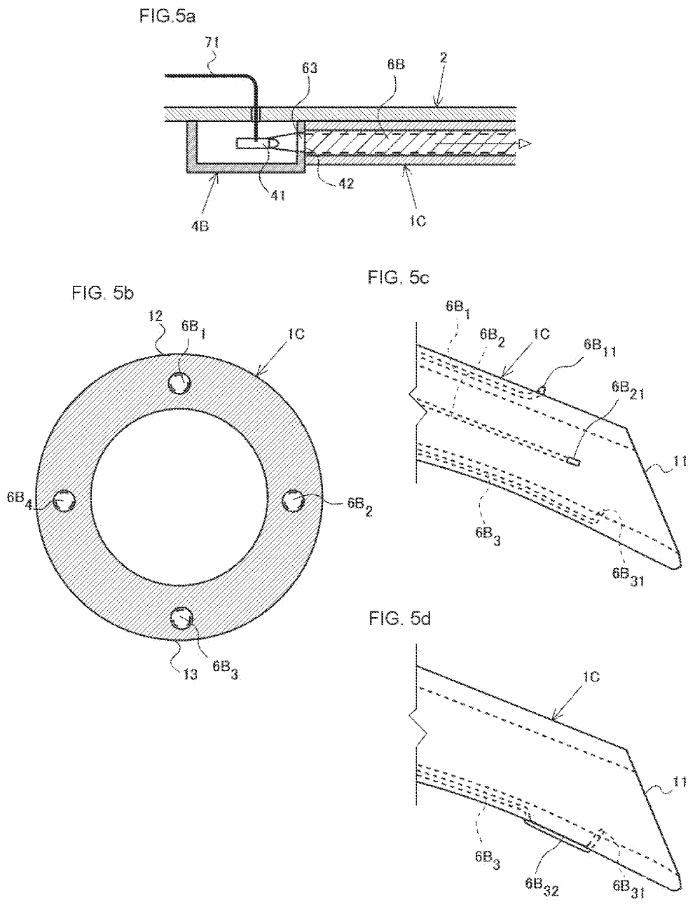

FIG. 5(a) is a schematic enlarged view of a region IVb illustrated in FIGS. 3(a) and (b) illustrates a schematic sectional view taken along a line Vb-Vb illustrated in FIG. 3(a). The suffices a and b illustrated in FIGS. 4 and 5 indicate different variations.

The second embodiment is described with reference to FIGS. 3 and 4. As illustrated in FIG. 3, one or a plurality of light source units 4B are attached to the inner surface of the vacuum hose 2 in the vicinity of the distal end of the vacuum hose 2. When a plurality of the light source units 4B are attached, the light source units 4B are arranged at a predetermined interval in the circumferential direction on the inner surface of the vacuum hose 2. Each of the light source units 4B includes an appropriate housing fixed to the inner surface of the vacuum hose 2 and a light source device 41 accommodated in the housing. In this case, each of the light source units 4B is designed such that the size of the light source unit 4B does not affect the suction function of the suction device.

The internal configuration of the light source unit 4B is the same as that of the light source unit 4A according to the first embodiment described above. The light source device 41 is, for example, an LED, a halogen lamp, or the like. The light emitting face 42 of the light source device 41 faces the distal end side of the vacuum hose 2. The light emitting face 42 is orthogonal to the axis of the cylindrical joint portion 3 illustrated in FIG. 3(a). In the second embodiment, the light emitting face 42 of the light source device 41 is a hose-side light-outputting end face. When a plurality of the light source devices 4B are attached, the light emitting face 42 is provided in plural.

In another example of the light source unit 4B, as illustrated in FIG. 3(c), a base end of the hose-side optical fiber 43 having a predetermined length may be connected to the light emitting face 42 of the light source 41, and the distal end face 44 of the hose-side optical fiber 43 may face the distal end side of the vacuum hose 2. In this case, the distal end face 44 of the hose-side optical fiber 43 is a hose-side light-outputting end face.

In the second embodiment, the control unit 7 is attached to the outer surface of the vacuum hose 2. The control unit 7 is connected to a power supply (not illustrated) via a conductive line. The control unit 7 has the same configuration as that described in the first embodiment and includes a switch that turns on and off supply of power to the light source unit 4B and an adjuster that adjusts the intensity of lighting as needed. As illustrated in FIG. 4(a), the control unit 7 and the light source unit 4B are electrically connected to each other via a conductive line 71 extending through a through-hole 72 of a tube wall of the vacuum hose 2. When the light source unit 4B is provided in plural, power can be supplied from the single control unit 7 to the plurality of light source units 4B.

As illustrated in the sectional view of FIG. 4(b), almost the entire tube body of a vacuum tip 1B forms a tube-shaped light guide made of a uniform material (for example, Japanese Patent Application National Publication No. 2012-522302). This light guide is formed by, for example, molding transparent acrylic resin into the shape of the vacuum tip 1B. For example, the light guide is configured such that inner and outer surfaces of a tube wall serve as mirror surfaces for the inside of the tube wall, except for a light receiving portion and a light projecting portion. Therefore, for example, an appropriate reflective coating layer may be disposed on each of the inner and outer surfaces of the tube wall. As a result, the light guide receives light from the light source arranged outside, allows the received light to be fully reflected and travel within the tube wall, and projects the light to the outside from its distal end or from its side surface in the middle as needed. Therefore, in the second embodiment, the tube body itself of the vacuum tip 1B is a light guiding element of the vacuum tip 1B.

As illustrated in FIG. 4(a), a base end face 15 of the tube body of the vacuum tip 1B is orthogonal to the axis of the cylindrical joint portion 3 illustrated in FIG. 3(a). The base end face 15 obviously faces the base end side of the vacuum tip 1B. In the second embodiment, the base end face 15 of the vacuum tip 1B is a tip-side light-receiving end face.

Light input from the base end face 15 travels toward the distal end while being fully reflected within the tube wall of the vacuum tip 1. Lastly, the light reaches the suction opening 11 of the distal end of the vacuum tip 1B and is projected from the suction opening 11. Preferably, as illustrated in FIG. 4(c), for example, the light can be projected from the side surface of the tube body to the outside by forming a plurality of grooves or protrusions or a prism portion 16 having a rough surface at a portion of the tube wall of the vacuum tip 1B. At the light projecting portion, a reflective coating layer is not provided on the outer surface of the tube body. Various methods for projecting light from the side surface of the light guide are known.

In the oral cavity suction device illustrated in FIGS. 3 and 4, when the vacuum tip 1B and the vacuum hose 2 are changed from a detached state illustrated in FIG. 3(b) to an inserted state illustrated in FIG. 3(a), that is, in a state in which the vacuum tip 1B is completely connected to the vacuum hose 2, the one or more light emitting faces 42 that serve as the hose-side light-outputting end face and the base end face 15 of the tube body of the vacuum tip 1B that is a tip-side light-receiving end face are opposed to each other and can be in contact with each other in a state in which light can be transmitted. In addition, in the embodiment illustrated in FIG. 3(c), the distal end face 44 of the hose-side optical fiber 43 connected to the light source unit 4B and the base end face 15 of the tube body of the vacuum tip 1B that is a tip-side light-receiving end face are opposed to each other and can be in contact with each other in a state in which light can be transmitted.

Next, modifications of the second embodiment are described with reference to FIGS. 3 and 5. However, a light guiding element of a vacuum tip 1C according to a modification is not specifically represented in FIG. 3 and is illustrated in FIG. 5.

The modification illustrated in FIG. 5 is different from the second embodiment illustrated in FIG. 4 in the light guiding element of the vacuum tip 1C, but is common to the second embodiment in terms of configurations excluding the light guiding element. Therefore, in this case, a hose-side light-outputting end face is the light emitting face 42 (the distal end face 44 of the hose-side optical fiber 43 for the light source unit 4B illustrated in FIG. 3(c)) of the light source device 41.

As illustrated in FIG. 5(a), the vacuum tip 1C has one or a plurality of tip-side optical fibers 6B extending in the longitudinal direction in the tube wall of the vacuum tip 1C. The distal end of the tip-side optical fiber 6B is positioned at or near the distal end of the vacuum tip 1C. In this case, the tip-side optical fiber 6B is the light guiding element of the vacuum tip 1C. The base end face 63 of the tip-side optical fiber 6B is a tip-side light-receiving end face. The base end face 63 of the tip-side optical fiber 6B is positioned in the same plane as the base end face of the vacuum tip 1C. Therefore, the base end face 63 of the tip-side optical fiber 6B obviously faces the base end side of the vacuum tip 1C.

When a plurality of the light source units 4B are attached to the inner surface of the vacuum hose 2 in the circumferential direction, the tip-side optical fiber 6B is provided in plural corresponding to the light source units 4B in the vacuum tip 1C. The number of light source units 4B may be 2 to 6, for example. In this case, when the vacuum tip 1 is inserted in the vacuum hose 2, the position of each tip-side optical fiber 6B is set such that the position of the base end face 63 of each tip-side optical fiber 6B matches the position of each light emitting face 42.

In the schematic sectional view illustrated in FIG. 5(b) and taken along a line Vb-Vb of FIG. 3, as an example, the vacuum tip 1C includes four tip-side optical fibers 6B₁, 6B₂, 6B₃, and 6B₄ (the tip-side optical fibers are distinguished using the subscripts) embedded at angular intervals of 90 degrees. The positions of the tip-side optical fibers 6B in the circumferential direction are not limited to the illustrated examples. The light source unit 4B may be provided in plural such that the number of tip-side optical fibers 6B arranged close to the operation-side surface 12 illustrated in FIG. 3(c) is large.

Light input to the tip-side optical fibers 6B can be projected from the distal ends of the tip-side optical fibers 6B. In a case where the tip-side optical fibers 6B extend to the distal end of the vacuum tip 1C and light is projected from only the distal end of the vacuum tip 1C, the tube body of the vacuum tip 1C may not be transparent or translucent. In another example, light can be projected from the side surfaces of the tip-side optical fibers 6B, preferably from the side surfaces present near the distal ends. When light is projected from the side surfaces of the tip-side optical fibers 6B, at least a light projecting portion of the tube body of the vacuum tip 1C needs to be transparent or translucent to allow light to pass through the light projecting portion. The transparent or translucent material is, for example, acrylic resin but is not limited thereto.

FIGS. 5(c) and (d) exemplify still other modifications and are schematic side views of a portion near the distal end of the vacuum tip 1C. In this case, a distal end of one or a plurality of the tip-side optical fibers 6B or a portion of one or a plurality of the tip-side optical fibers 6B that is present near the distal end is exposed on the outer surface or the inner surface of the tube body of the vacuum tip 1C. In FIG. 5(c), distal ends 6B₁₁ and 6B₂₁ of tip-side optical fibers 6B₁ and 6B₂ are exposed on the outer surface of the tube body, while a distal end 6B₃₁ of a tip-side optical fiber 6B₃ is exposed on the inner surface of the tube body. In FIG. 5(d), a portion 6B₃₂ of the tip-side optical fiber 6B₃ that is present near the distal end of the tip-side optical fiber 6B₃ is exposed on the outer surface of the tube body by a predetermined length and penetrates the tube wall, and the distal end 6B₃₁ is exposed on the inner surface of the tube body. In this modification, light is emitted from at least a portion exposed on the outer surface or the inner surface of the tube body. In this case, the tube body of the vacuum tip 1C may not be transparent or translucent.

In the oral cavity suction device illustrated in FIGS. 3 and 5, when the vacuum tip 1C and the vacuum hose 2 are changed from a detached state illustrated in FIG. 3(b) to an inserted state illustrated in FIG. 3(a), that is, in a state in which the vacuum tip 1C is completely connected to the vacuum hose 2, the one or more limit emitting faces 42 (the distal end face 44 of the hose-side optical fiber 43 for the light source unit 4B illustrated in FIG. 3(c)) that serve as the hose-side light-outputting end face and the base end face 63 of each of the one or more tip-side optical fibers 6B that is a tip-side light-receiving end face are opposed to each other and can be in contact with each other in a state in which light can be transmitted.

Although not illustrated in the drawings, the second embodiment and the modification thereof may be carried out in combination with the first embodiment described above.

### (3) Third Embodiment and Modifications Thereof

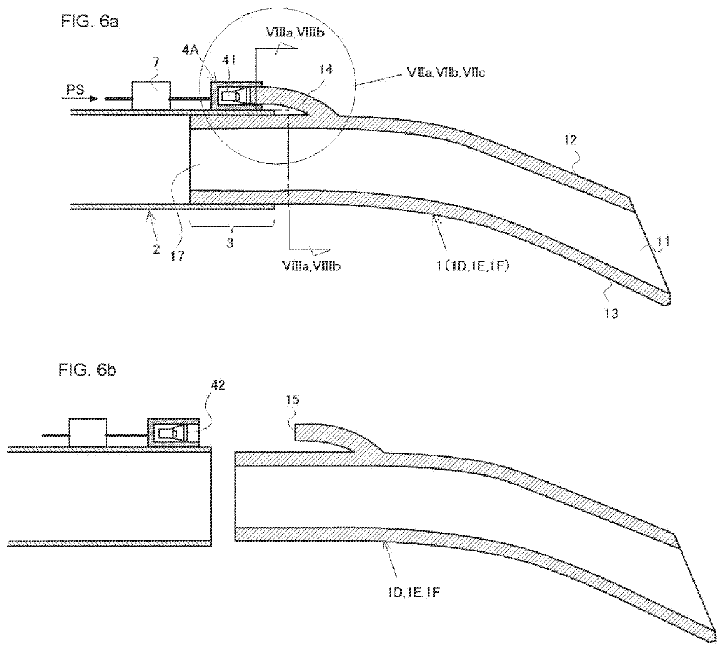

An oral cavity suction device according to a third embodiment of the present invention and modifications thereof are described with reference to FIGS. 6, 7, and 8.

FIG. 6 are schematic sectional views of the oral cavity suction device with lighting according to the third embodiment, where (a) illustrates a state in which the vacuum tip 1 is connected to the vacuum hose 2, and (b) illustrates a state in which the vacuum tip 1 is disconnected from the vacuum hose 2.

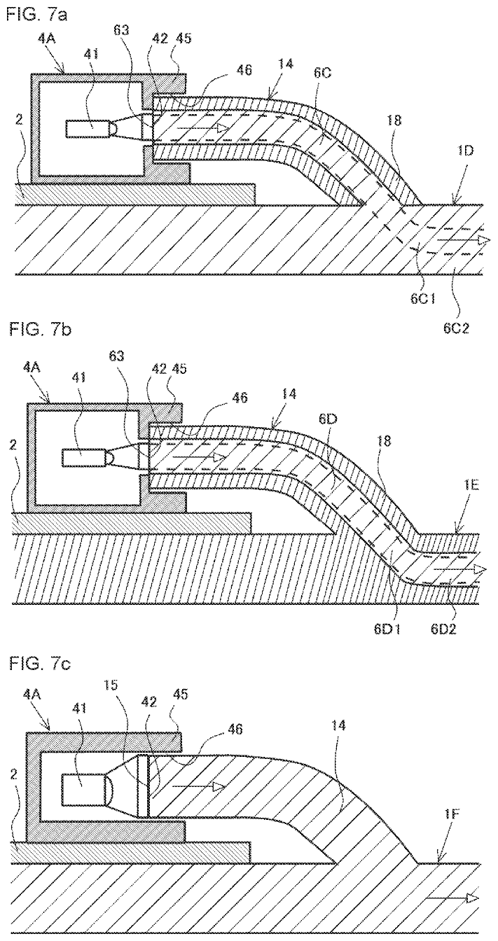

FIG. 7(a) is a schematic enlarged view of a region VIIa illustrated in FIG. 6(a), (b) is a schematic enlarged view of a region VIIb illustrated in FIG. 6(a), and (c) is a schematic enlarged view of a region VIIc illustrated in FIG. 6(a). The suffices a, b, and c indicate different variations.

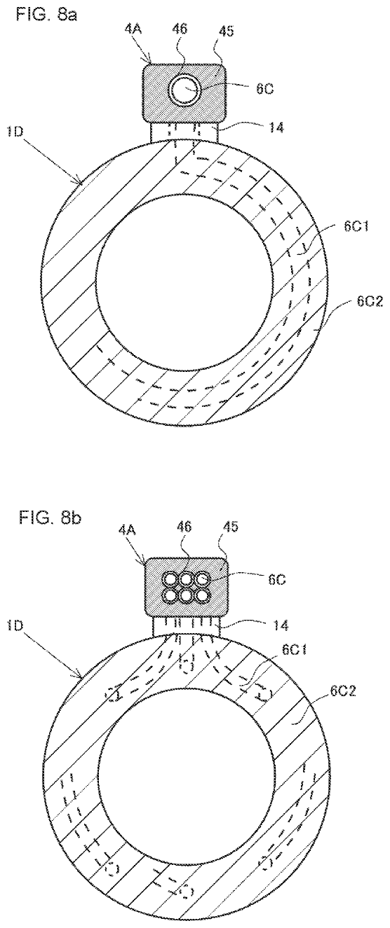

FIG. 8(a) is a schematic sectional view taken along a line VIIIa-VIIIa illustrated in FIGS. 6(a) and (b) is a schematic sectional view taken along a line VIIIb-VIIIb illustrated in FIG. 6(a). The suffices a and b indicate different variations.

The oral cavity suction device according to the third embodiment is described with reference to FIGS. 6, 7(a), and 8. However, a light guiding element of the vacuum tip 1D according to the third embodiment is not specifically represented in FIG. 6 and is illustrated in FIG. 7(a).

As illustrated in FIG. 6(a), the light source unit 4A is attached to the outer surface of the vacuum hose 2 in the vicinity of the distal end of the vacuum hose 2. The light source unit 4A includes an appropriate housing fixed to the outer surface of the vacuum hose 2 and a light source device 41 accommodated in the housing. The internal configuration of the light source unit 4A is the same as that of the light source unit 4A according to the first embodiment. The light source device 41 is, for example, an LED, a halogen lamp, or the like. The light emitting face 42 of the light source device 41 faces the distal end side of the vacuum hose 2. The light emitting face 42 is orthogonal to the axis of the cylindrical joint portion 3 illustrated in FIG. 6(a). In the third embodiment, the light emitting face 42 of the light source device 41 is a hose-side light-outputting end face. The control unit 7 connected to the light source unit 4A may have the same configuration as that of the control unit 7 according to the first embodiment. The light source unit 4A may be provided in plural in the circumferential direction of the vacuum hose 2.

As schematically illustrated in FIG. 6(a), a vacuum tip 1D has a branch portion 14 in the vicinity of the base end of the vacuum tip 1D on the distal end side with respect to the joint portion 3. The branch portion 14 is branched from the outer surface of the tube body, slightly protrudes from the outer surface of the tube body, and extends toward the base end side of the vacuum tip 1D by a predetermined length. The branch portion 14 includes a part of a light guiding element of the vacuum tip 1D. The branch portion 14 protrudes for positioning of the light guiding element. When the light source unit 4A is provided in plural, the branch portion 14 is also provided in plural corresponding to the light source units 4A.

FIG. 7(a) illustrates a region including the branch portion 14 in an enlarged manner. The tube body of the vacuum tip 1D includes a core portion 6C1 extending in a tube wall in the longitudinal direction and a cladding portion 6C2 forming a tube wall region excluding the core portion 6C1. The core portion 6C1 is made of the same material as that of a core of a general resin optical fiber and the cladding portion 6C2 is made of the same material as that of a cladding of a general resin optical fiber. The tube body of the vacuum tip 1D has the same structure as that of a general resin optical fiber. Light transmitted in the core portion 6C1 may be projected from the suction opening 11 of the distal end. In addition, light transmitted in the core portion 6C1 may be projected from the side surface of the tube body, preferably from the side surface present near the distal end, instead of or in addition to the projection from the distal end.

On the other hand, an input optical fiber 6C extends through the inside of the branch portion 14 in the longitudinal direction. The input optical fiber 6C is protected and fixed by being surrounded and sealed by an optical fiber support portion 18 made of hard resin or the like. The core of the input optical fiber 6C is continuous to the core portion 6C1 of the tube body and made of the same material as that of the core portion 6C1. The cladding of the input optical fiber 6C is continuous to the cladding portion 6C2 of the tube body and made of the same material as that of the cladding portion 6C2. Therefore, in the third embodiment, the tube body itself of the vacuum tip 1D and the input optical fiber 6C are the light guiding element.

The free end 63 of the input optical fiber 6C is present in the same plane as a free end of the branch portion 14. A portion including the free end 63 of the input optical fiber 6C can be inserted in the recess 46 of the support portion 45 formed on the distal end side of the housing of the light source unit 4A. The recess 46 is effective for positioning and support but is not essential. The free end 63 of the input optical fiber 6C is a tip-side light-receiving end face.

In the oral cavity suction device illustrated in FIGS. 6 and 7(a), when the vacuum tip 1D and the vacuum hose 2 are changed from a detached state illustrated in FIG. 6(b) to an inserted state illustrated in FIG. 6(a), that is, in a state in which the vacuum tip 1D is completely connected to the vacuum hose 2, the light emitting face 42 that is a hose-side light-outputting end face and the free end 63 of the input optical fiber 6C that is a tip-side light-receiving end face are opposed to each other and can be in contact with each other such that light can be transmitted.

Modifications of the third embodiment illustrated in FIG. 7(a) are described with reference to FIGS. 8(a) and (b). In the modification illustrated in FIG. 8(a), the core portion 6C1 of the vacuum tip 1D spirally extends toward the distal end in a tube wall along the spiral axis of a tube body.

In another modification illustrated in FIG. 8(b), a plurality of input optical fibers 6C extend through the branch portion 14 as a single flux and cores of the input optical fibers 6C are continuous to a plurality of core portions 6C1 arranged in the tube wall. Each of the core portions 6C1 spirally extends in the tube wall toward the distal end with the axis of the tube body serving as the spiral axis. In each of the modifications illustrated in FIGS. 8(a) and (b), the surroundings of the vacuum tip 1D can be entirely illuminated by projecting light from the side surface of the tube body.

Although not illustrated in the drawings, the light guiding element in the tube wall of the vacuum tip may be spirally arranged with the axis of the tube body serving as the spiral axis, instead of being arranged along the longitudinal direction of the tube body.

Referring back to FIG. 7(b), still another modification of the third embodiment is described. FIG. 7(b) illustrates a region including the branch portion 14 in an enlarged manner. In a vacuum tip 1E, a tip-side optical fiber 6D extends in the longitudinal direction in a tube wall. The distal end of the tip-side optical fiber 6D is positioned at or near the suction opening 11. The tip-side optical fiber 6D includes a core 6D1 and a cladding 6D2, like a general optical fiber. Therefore, in this modification, the tip-side optical fiber 6D is a light guiding element of the vacuum tip 1E. Light transmitted in the tip-side optical fiber 6D may be projected from the distal end of the tip-side optical fiber 6D. Instead of or in addition to the projection from the distal end, light may be projected from the side surface of the tip-side optical fiber 6D, preferably from the side surface present near the distal end. In a case where light is projected only from the distal end of the tip-side optical fiber 6D, the material of a tube body surrounding the tip-side optical fiber 6D does not need to be transparent. In a case where light is projected from the side surface, at least a light projecting portion of the tube body is made of a transparent or translucent material.

As another example, the distal end of the tip-side optical fiber 6D or a portion of the tip-side optical fiber 6D that is present near the distal end may be exposed on the outer surface or the inner surface of the tube body of the vacuum tip 1E in the same manner as the example illustrated in FIG. 5(c).

The tip-side optical fiber 6D is drawn from the outer surface of the tube body in the vicinity of the base end of the tube body and extends through the inside of the branch portion 14 toward the base end side of the vacuum tip 1E by a predetermined length. The base end of the tip-side optical fiber 6D is positioned in the same plane as the free end of the branch portion 14. At the branch portion 14, the tip-side optical fiber 6D is protected and fixed by being surrounded and sealed by the optical fiber support portion 18 made of hard resin or the like. The base end of the tip-side optical fiber 6D can be inserted in the recess 46 of the support portion 45 formed on the distal end side of the housing of the light source unit 4A. The recess 46 is effective for positioning and support but is not essential. The base end face 63 of the tip-side optical fiber 6D is a tip-side light-receiving end face.

In the oral cavity suction device illustrated in FIGS. 6 and 7(b), when the vacuum tip 1E and the vacuum hose 2 are changed from a detached state illustrated in FIG. 6(b) to an inserted state illustrated in FIG. 6(a), that is, in a state in which the vacuum tip 1E is completely connected to the vacuum hose 2, the light emitting face 42 that is a hose-side light-outputting end face and the base end face 63 of the tip-side optical fiber 6D that is a tip-side light-receiving end face are opposed to each other and can be in contact with each other such that light can be transmitted.

Next, still another modification of the third embodiment is described with reference to FIG. 7(c). FIG. 7(c) illustrates a region including the branch portion 14 in an enlarged manner. A tube body of a vacuum tip 1F and the branch portion 14 forms a light guide. For example, the light guide is made of transparent acrylic resin and a reflective coating layer is provided on the surface of the light guide as needed, like the tube body of the vacuum tip 1B according to the second embodiment described above. Light input from a free end of the branch portion 14 is fully reflected, enters the tube body of the vacuum tip 1F from the branch portion 14, and is guided toward the distal end. The light can be projected from the distal end or the side surface of the vacuum tip 1F in the middle as needed, like the vacuum tip 1B described above. Therefore, in this modification, the tube body itself of the vacuum tip 1F and the branch portion 14 are a light guiding element of the vacuum tip 1F.

The branch portion 14 can be inserted in the recess 46 of the support portion 45 formed in the housing of the light source unit 4A. The recess 46 is effective for positioning but is not essential. A free end 15 of the branch portion 14 is a tip-side light-receiving end face.

In the oral cavity suction device illustrated in FIGS. 6 and 7(c), when the vacuum tip 1E and the vacuum hose 2 are changed from a detached state illustrated in FIG. 6(b) to an inserted state illustrated in FIG. 6(a), that is, in a state in which the vacuum tip 1E is completely connected to the vacuum hose 2, the light emitting face 42 that is a hose-side light-outputting end face and the free end 15 of the branch portion 14 that is a tip-side light-receiving end face are opposed to each other and can be in contact with each other such that light can be transmitted.

In the examples illustrated in FIGS. 6 to 8, the single light source unit 4A and the single branch portion 14 are illustrated in the drawings. However, as another example, a plurality of light source units 4A are provided, a plurality of branch portion 14 are provided, the light source units 4A may be arranged at a predetermined interval on the outer surface of the vacuum hose 2 in the circumferential direction of the outer surface of the vacuum hose 2, and the branch portions 14 corresponding to the light source units 4A may be arranged at a predetermined interval on the outer surface of the vacuum tip 1 in the circumferential direction of the outer surface of the vacuum tip 1.

### (4) Fourth Embodiment and Modifications Thereof

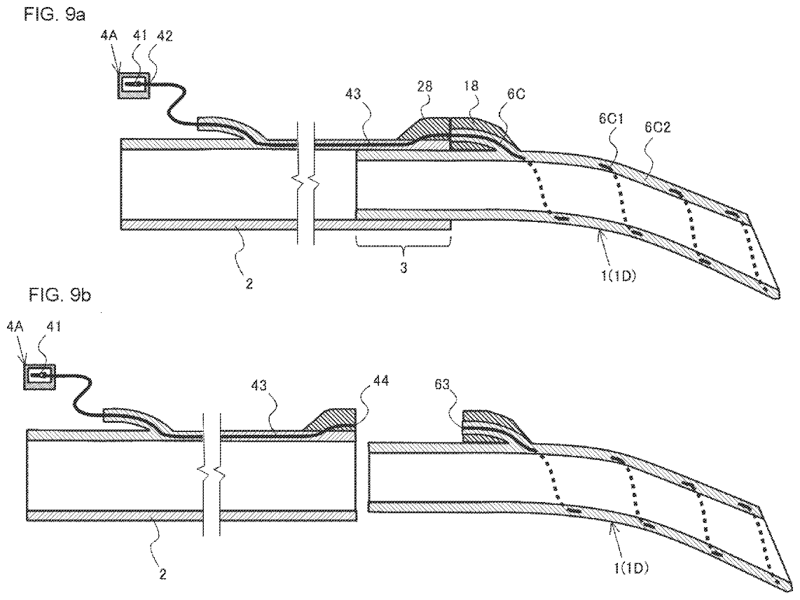

An oral cavity suction device according to a fourth embodiment of the present invention is described with reference to FIG. 9. FIG. 9 are schematic sectional views of the oral cavity suction device with lighting according to the fourth embodiment, where (a) illustrates a state in which the vacuum tip 1 is connected to the vacuum hose 2 and (b) illustrates a state in which the vacuum tip 1 is disconnected from the vacuum hose 2.

In the fourth embodiment, the configuration of the vacuum hose 2 is different from those described above in the embodiments. The light source unit 4A accommodating the light source device 41 is not attached to the vacuum hose 2. The light source unit 4A is provided at any position (for example, on the floor of a dental treatment room). In this case, for example, a control unit that controls a power supply can be included in the light source unit 4A or included in an operational panel of a dental unit.

The base end of the hose-side optical fiber 43 is connected to the light emitting face 42 of the light source unit 4A. The hose-side optical fiber 43 is provided in the hose wall of the vacuum hose 2 at a predetermined position in the middle of the vacuum hose 2. The hose-side optical fiber 43 extends through the inside of the hose wall to the distal end of the vacuum hose 2.

In the illustrated example, a portion of the hose-side optical fiber 43 that is present near the distal end of the hose-side optical fiber 43 is drawn from the outer surface of the vacuum hose 2 toward the outer side and extends to the distal end of the vacuum hose 2. The outer part of the drawn distal-end portion of the hose-side optical fiber 43 is protected and fixed by being sealed by an optical fiber support portion 28 made of hard resin or the like. In this case, the distal end face 44 of the hose-side optical fiber 43 is a hose-side light-outputting end face.

In FIG. 9, as the vacuum tip 1 to be combined with the vacuum hose 2, the vacuum tip 1D (the core portion 6C1 is spirally arranged) illustrated in FIG. 8(a) described above is combined with the vacuum hose 2. However, this is an example and the vacuum tips 1A, 1E, and 1F can be combined as the vacuum tip 1. That is, the vacuum hose 2 illustrated in FIG. 9 can be combined with a vacuum tip having a tip-side light-receiving end face on the outer side of a tube body.

In the oral cavity suction device illustrated in FIG. 9, when the vacuum tip 1 and the vacuum hose 2 are changed from a detached state illustrated in FIG. 9(b) to an inserted state illustrated in FIG. 9(a), that is, in a state in which the vacuum tip 1 is completely connected to the vacuum hose 2, the distal end face 44 that is a hose-side light-outputting end face and the base end face 63 that is a tip-side light-receiving end face are opposed to each other and can be in contact with each other such that light can be transmitted.

Although not illustrated in the drawings, as another example, the distal end portion of the hose-side optical fiber 43 may not be drawn toward the outer side of the vacuum hose 2 and may linearly extend to the distal end of the hose wall. In this case, the position of the tip-side light-receiving end face of the vacuum tip 1A, 1D, 1E, or 1F to be combined is set to a position where the tip-side light-receiving end face is opposed to the distal end face 44 of the hose-side optical fiber 43.

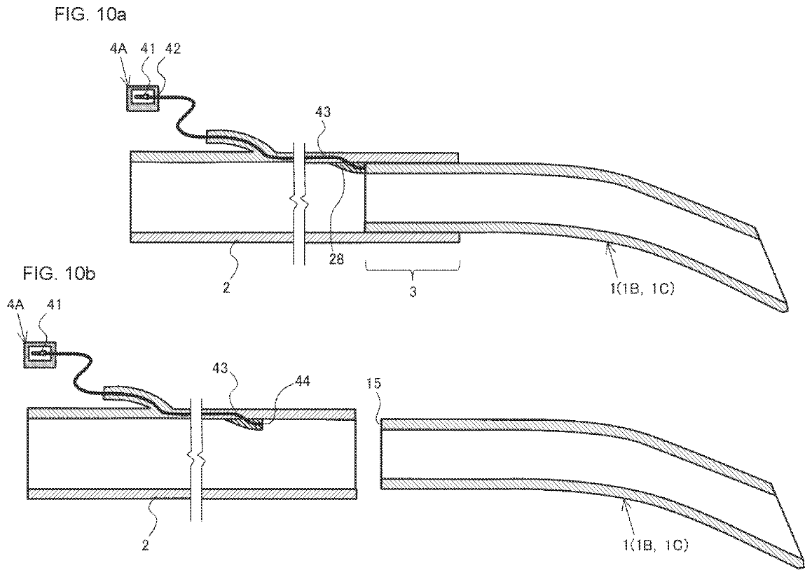

A modification of the fourth embodiment is described with reference to FIG. 10. FIG. 10 are schematic sectional views of the modification of the fourth embodiment, where (a) illustrates a state in which the vacuum tip 1 is connected to the vacuum hose 2 and (b) illustrates a state in which the vacuum tip 1 is disconnected from the vacuum hose 2.

In this modification, the distal-end portion of the hose-side optical fiber 43 is drawn from the inner surface of the vacuum hose 2 and extends toward the distal end of the vacuum hose 2 by a predetermined length. The drawn distal-end portion of the hose-side optical fiber 43 is protected and fixed by being sealed by the optical fiber support portion 28 made of hard resin or the like.

Each of the vacuum tips 1B and 1C illustrated in FIG. 3 described above can be combined with the vacuum hose 2 illustrated in FIG. 10. That is, the vacuum hose 2 illustrated in FIG. 10 can be combined with a vacuum tip having a tip-side light-receiving end face at the base end face of the tube body.

In the oral cavity suction device illustrated in FIG. 10, when the vacuum tip 1 and the vacuum hose 2 are changed from a detached state illustrated in FIG. 10(b) to an inserted state illustrated in FIG. 10(a), that is, in a state in which the vacuum tip 1 is completely connected to the vacuum hose 2, the distal end face 44 that is a hose-side light-outputting end face and the base end face 15 of the tube body of the vacuum tip 1 that is a tip-side light-receiving end face are opposed to each other and can be in contact with each other such that light can be transmitted.

Although not illustrated in the drawings, as another modification of the fourth embodiment, the hose-side optical fiber 43 can be attached to the outer surface or the inner surface of the vacuum hose 2 in the longitudinal direction, instead of extending in the hose wall of the vacuum hose 2.

Although FIGS. 9 and 10 illustrate the single hose-side optical fiber 43, a plurality (for example, 2 to 6) of the hose-side optical fibers 43 may be arranged at appropriate intervals in the circumferential direction of the vacuum hose 2. In this case, the vacuum tip 1 having light guiding elements corresponding to the plurality of hose-side optical fibers 43 is combined. In addition, a single hose-side optical fiber 43 may be one flux of a plurality of optical fibers.

### (5) Embodiment in Which Attachment is Provided

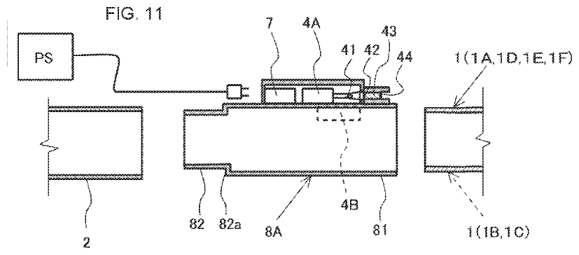

Another aspect of the present invention is an embodiment in which an attachable attachment is provided between a vacuum hose and a vacuum tip. FIG. 11 illustrates a schematic sectional view of an oral cavity suction device with lighting including an attachment 8A.

In each of the oral cavity suction devices according to the first to third embodiments, the light source unit 4A or 4B and the control unit 7 are fixed to the vacuum hose 2. In addition, in the fourth embodiment, the hose-side optical fiber 43 is fixed to the vacuum hose 2. In these embodiments, it is necessary to process a general vacuum hose. By using the attachment 8A illustrated in FIG. 11, such processing is not required and a general vacuum hose can be used as it is.

The attachment 8A has a tube body connectable to the vacuum tip 1 and the vacuum hose 2. The tube body preferably has a substantially cylindrical shape. The material of the tube body may be the same as the material of the vacuum tip 1 and is, for example, plastic or metal. A base end 82 of the tube body can be inserted in the distal end of the vacuum hose 2, and the base end of the vacuum tip 1 can be inserted in a distal end 81 of the tube body. The lengths of joint portions at both end portions of the attachment 8A are set to the same length as that of the joint portion at which the vacuum tip 1 is connected directly to the vacuum hose 2. Therefore, for example, a step 82a is provided at a boundary between the base end 82 and a central portion of the tube body. A stopper (not illustrated) such as a protrusion can be provided on the inner surface of the tube body. An inner space of the attachment 8A serves as a path of a suctioned object.

A housing accommodating the light source unit 4A and the control unit 7 illustrated in FIG. 1 described above is attached to the outer surface of the tube body of the attachment 8A. Although not illustrated in the drawings, an operation switch is also provided in the housing. Alternatively, the control unit 7 may be provided in an operation panel of a dental unit.

A relatively short optical fiber 43 is connected to a side surface of the housing of the light source unit 4A on the vacuum tip side. The distal end face 44 of the optical fiber 43 is a light-outputting end face for light from the light source. As another example, the optical fiber 43 may be omitted and the light emitting face 42 of the light source device 41 may be a light-outputting end face. In both cases, the light-outputting end face faces the distal end side of the attachment 8A. The light-outputting end face of the attachment 8A is an element corresponding to the hose-side light-outputting end face in each of the embodiments described above. In the housing, a connector to be connected to an external power supply is provided. When a battery or a rechargeable battery is incorporated in the housing, the external power supply is not required. It is sufficient if the attachment 8A has a length in the axial direction sufficient to have these components incorporated therein.

A vacuum tip having a tip-side light-receiving end face on an outer surface of a tube body can be combined with the attachment 8A having the light source unit 4A. Examples of the vacuum tip are the vacuum tips 1A, 1D, 1E, and 1F of the oral cavity suction devices described above.

As a modification, as indicated by a dotted line in FIG. 11, the light source unit 4B illustrated in FIG. 3 can be provided on the inner surface of the tube body of the attachment 8A (also in this case, the control unit 7 is provided on the outer surface). In this case, a vacuum tip having a tip-side light-receiving end face in a base end face of a tube body can be combined. Examples of the vacuum tip are the vacuum tips 1B and 1C described above.

Although not illustrated in the drawings, the single control unit 7 and the plurality of light source units 4A and 4B can be provided on the attachment 8A. In this case, the plurality of light source units 4A and 4B are arranged at a predetermined interval in the circumferential direction on the outer surface or the inner surface of the attachment 8A.

As an example of a method of using the attachment 8A, the vacuum hose 2 may be connected to the attachment 8A at all times. In order to replace the vacuum tip 1, the vacuum tip 1 is detached from the attachment 8A and a new vacuum tip 1 is inserted in the attachment 8A. When the vacuum tip 1 is inserted in the attachment 8A, that is, when the vacuum tip 1 is completely connected to the attachment 8A, optical connection to the light source is completed.

### (6) Another Embodiment in Which Attachment is Provided

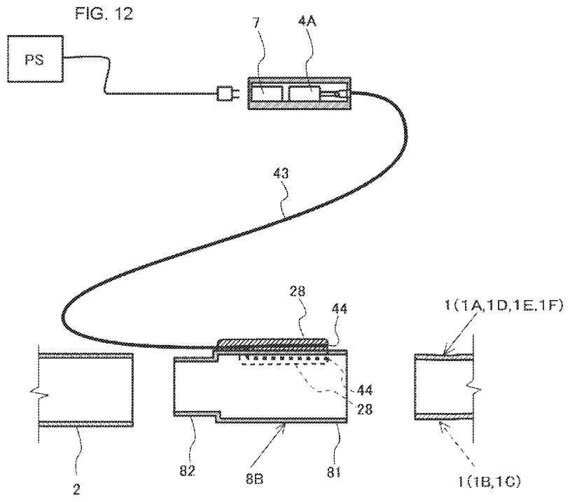

FIG. 12 illustrates a schematic sectional view of an oral cavity suction device with lighting and an attachment according to another embodiment.

The attachment 8B has a tube body connectable to the vacuum tip 1 and the vacuum hose 2. The tube body of the attachment 8B is the same as the tube body of the attachment 8A illustrated in FIG. 11. A distal end of the optical fiber 43 and a portion of the optical fiber 43 present near the distal end are fixed to the outer surface of the tube body of the attachment 8B. Therefore, the distal-end portion of the optical fiber 43 is protected and fixed by being sealed by the optical fiber support portion 28 made of hard resin or the like. The distal end face 44 of the optical fiber 43 faces the distal end side of the attachment 8B. The distal end face 44 is a light-outputting end face. It is sufficient if the attachment 8B has a length in the axial direction sufficient to stably fix the distal-end portion of the optical fiber 43.

The base end of the optical fiber 43 is connected to the light source unit 4A. In this embodiment, as an example, the light source unit 4A and the control unit 7 are accommodated in a single housing and placed on an arbitrary place (for example, on the floor of a dental treatment room). The optical fiber 43 has a sufficient length corresponding to the distance between the attachment 8B and the light source unit 4A. An operation switch or the like that controls a power supply may be provided in the housing of the control unit 7, or a hand switch for operation or a foot switch may be provided at a distal end of an appropriate conductive line (not illustrated) connected to the control unit 7. Alternatively, the control unit 7 may be provided in an operation panel of a dental unit.

A vacuum tip having a tip-side light-receiving end face on an outer surface of a tube body can be combined with the attachment 8B having the distal end portion of the optical fiber 43. Examples of the vacuum tip are the vacuum tips 1A, 1D, 1E, and 1F of the oral cavity suction devices described above. A method of using the attachment 8B is the same as the method of using the attachment 8A illustrated in FIG. 11.

As a modification, as indicated by a dotted line in FIG. 12, the optical fiber 43 can penetrate the tube wall of the attachment 8B from the outer side to the inner side of the tube wall, and the distal end portion of the optical fiber 43 can be fixed to the inner surface of the tube body by the fiber support portion 28. In this case, a vacuum tip having a tip-side light-receiving end face at a base end face of a tube body can be combined and examples of the vacuum tip are the vacuum tips 1B and 1C described above.

Although not illustrated in the drawings, the distal end portion of the optical fiber 43 may be branched into a plurality of optical fibers. In this case, the plurality of optical fibers are arranged at a predetermined interval in the circumferential direction on the outer surface or the inner surface of the attachment 8B.

### (7) Embodiment in Which Locking Mechanism of Joint Portion is Provided

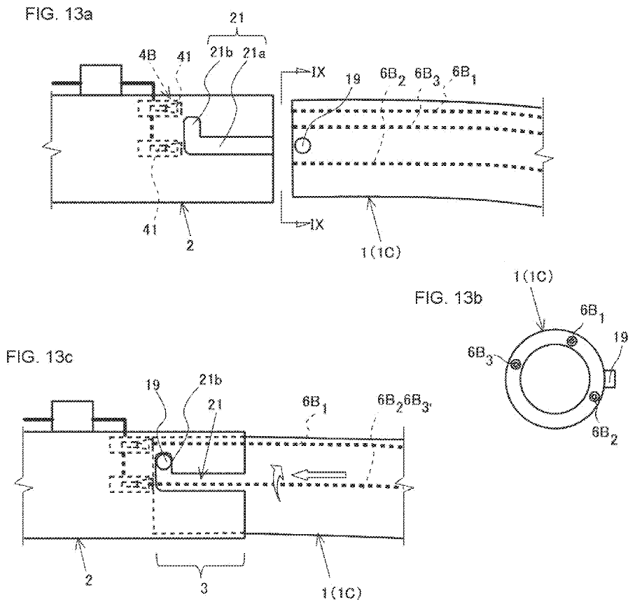

FIG. 13 illustrate an oral cavity suction device with lighting provided with a locking mechanism at the joint portion 3 of a vacuum hose and a vacuum tip according to an embodiment. FIG. 13 illustrate only the joint portion 3 and a portion present near the joint portion 3. FIG. 13(a) is a schematic side view illustrating a state before connection, (b) is a diagram of the vacuum tip 1C illustrated in FIG. 13(a) as viewed in an IX direction, and (c) is a schematic side view of a state after completion of connection.

In each of the embodiments described above, the vacuum tip 1 is completely connected to the vacuum hose 2 by inserting the vacuum tip 1 in the vacuum hose 2 in the longitudinal direction. On the other hand, in the present embodiment, the vacuum tip 1 is completely connected to the vacuum hose 2 by inserting the vacuum tip 1 in the vacuum hose 2 and turning the vacuum tip 1 in the circumferential direction.

As illustrated in FIG. 13(a), a notch portion 21 is formed in a part of a hose wall at the distal end of the vacuum hose 2. The notch portion 21 has a portion 21a extending from the distal end of the hose wall in the longitudinal direction and a portion 21b extending from the deepest part of the portion 21a in the circumferential direction. That is, the notch portion 21 extends in a substantially L shape as a whole. The length of the portion 21a is substantially equal to the length of the joint portion 3. The angular range of the portion 21b in the circumferential direction is, for example, in a range of 20 degrees to 90 degrees, but is not limited to this range.

Meanwhile, a locking protrusion 19 is formed on the outer surface of the tube body adjacent to the base end of the vacuum tip 1 and protrudes toward the outer side in the radial direction. In the illustrated example, the locking protrusion 19 has a substantially cylindrical shape. The maximum length (the diameter of the cylinder in the illustrated example) of the locking protrusion 19 in the circumferential direction of the vacuum tip 1 substantially corresponds to the width of the notch portion 21 of the vacuum hose 2. In addition, the height of the locking protrusion 19 is preferably equal to or larger than the thickness of the hose wall of the vacuum hose 2.

At least one pair of the notch portion 21 and the locking protrusion 19 is sufficient. However, both the notch portion 21 and the locking protrusion 19 may be provided in plural. For example, two pairs of the notch portions 21 and the locking protrusions 19 may be provided at a position of 0° and a position of 180° with respect to the axis of the joint portion 3.

In FIG. 13, as an example, the vacuum hose 2 illustrated in FIG. 3 and the vacuum tip 1C illustrated in FIG. 5 are combined. In this case, three light source devices 41 (only two illustrated in the drawing) are provided on the inner surface of the vacuum hose 2 and arranged in the circumferential direction. Three optical fibers 6B₁, 6B₂, and 6B₃ corresponding to the three light source devices 41 are provided in the tube wall of the vacuum tip 1C. In addition to this, various combinations of vacuum hoses 2 and vacuum tips 1 can be provided.

The notch portion 21 of the vacuum hose 2 is provided at a position where the notch portion 21 does not interfere with the light source devices provided in the vacuum hose 2 or the hose-side optical fibers provided in the vacuum hose 2. Similarly, the locking protrusion 19 of the vacuum tip 1 is provided at a position where the locking protrusion 19 does not interfere with the light guiding element of the vacuum tip 1.

A method for connecting the vacuum tip 1C to the vacuum hose 2 is described with reference to FIG. 13(c). First, the locking protrusion 19 of the vacuum tip 1C is aligned with the notch portion 21 of the vacuum hose 2, and the vacuum tip 1C is inserted in the vacuum hose 2 in the longitudinal direction (see a white arrow). After the locking protrusion 19 is inserted up to the deepest part of the portion 21a of the notch portion 21, the vacuum tip 1C is turned with respect to the vacuum hose 2 in the circumferential direction (see a white arrow). Accordingly, the locking protrusion 19 is inserted in the portion 21b and reaches the deepest part of the portion 21b. In this manner, the vacuum tip 1C is completely connected to the vacuum hose 2. The locking protrusion 19 is locked in the portion 21b and thus prevents the vacuum tip 1C from moving in the longitudinal direction. In this locked state, appropriate friction is preferably applied between the vacuum tip 1C and the vacuum hose 2 to prevent the vacuum tip 1C from easily turning with respect to the vacuum hose 2 in the circumferential direction.

When the vacuum tip 1C is completely connected to the vacuum hose 2, alignment of the light emitting faces of the three light source devices 41 of the vacuum hose 2 with the tip-side light-receiving end faces of the optical fibers 6B₁, 6B₂, and 6B₃ of the vacuum tip 1C is completed at the same time and the vacuum tip 1C and the vacuum hose 2 are in contact with each other. In order to realize this contact, the positions of the three light source devices 41 and the positions of the optical fibers 6B₁, 6B₂, and 6B₃ are set.

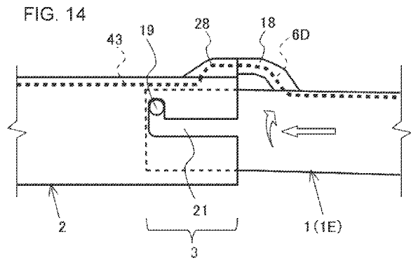

FIG. 14 is a schematic side view illustrating another example of a combination of the vacuum hose and the vacuum tip in an attached state in an embodiment in which a locking mechanism is provided. The vacuum hose 2 is the same as that in the embodiment illustrated in FIG. 9. The hose-side optical fiber 43 is embedded in the hose wall of the vacuum hose 2, drawn from the hose wall in the vicinity of the distal end, and supported and fixed by the fiber support portion 28. On the other hand, the vacuum tip 1E is the same as that in the embodiment illustrated in FIG. 7(b). The tip-side optical fiber 6D is embedded in the tube wall of the vacuum tip 1E, drawn from the tube wall in the vicinity of the base end, and supported and fixed by the fiber support portion 18.

At the joint portion 3, the notch portion 21 is formed on the hose side and the locking protrusion 19 is formed on the tip side. In this case, after the vacuum tip 1E is inserted in the vacuum hose 2 in the longitudinal direction as indicated by a white arrow, the vacuum tip 1E is completely connected to the vacuum hose 2 by turning the vacuum tip 1E in the circumferential direction. At the same time, the light-outputting end face of the distal end of the hose-side optical fiber 43 and the light-receiving end face of the base end of the tip-side optical fiber 6D are in contact with each other.

Although not illustrated in the drawings, the vacuum tip may have a notch portion and the vacuum hose may have a locking protrusion. In this case, the locking protrusion of the vacuum hose protrudes from the inner surface of the hose wall toward the inner side in the radial direction.

### (8) Embodiment in Which Attachment and Locking Mechanism are Provided

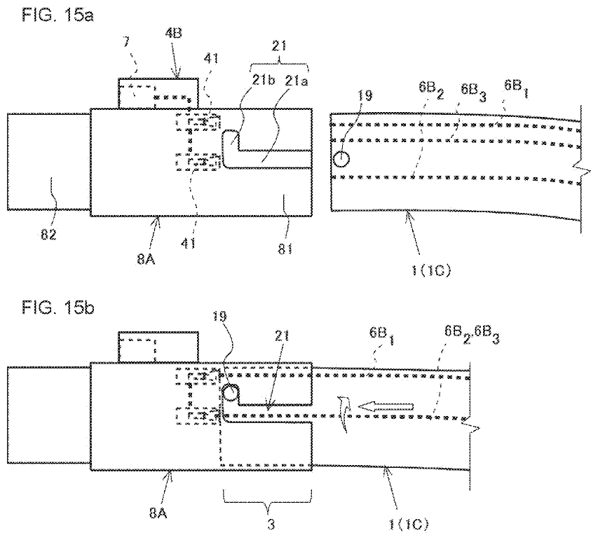

FIG. 15 illustrate an oral cavity suction device with lighting with a locking mechanism at the joint portion 3 of an attachment and a vacuum tip. FIG. 15 illustrate only the joint portion 3 and a portion present near the joint portion 3. FIG. 15(a) is a schematic side view of a state before connection and (b) is a schematic side view of a state after completion of connection.

As an example, the attachment is the same as the attachment 8A illustrated in FIG. 11. The three light source devices 41 (only two are illustrated) are provided on the inner surface of the tube body in the circumferential direction. The three optical fibers 6B₁, 6B₂, and 6B₃ extend in the tube wall of the vacuum tip 1C (in the same manner as the embodiment illustrated in FIG. 13). In addition to this, various combinations of attachments and vacuum tips can be made.

As illustrated in FIG. 15(a), the notch portion 21 is formed in a part of the tube wall at the distal end 81 of the tube body of the attachment 8A. The notch portion 21 has the portion 21a extending from the distal end of the tube wall in the longitudinal direction and the portion 21b extending from the deepest part of the portion 21a in the circumferential direction. That is, the notch portion 21 extends in a substantially L shape. The length of the portion 21a is substantially equal to the length of the joint portion 3. The angular range of the portion 21b in the circumferential direction is, for example, 20 degrees to 90 degrees, but is not limited thereto.

The locking protrusion 19 is formed on the vacuum tip 1C. The locking protrusion 19 is described above in the embodiment with reference to FIG. 13.

At least one pair of the notch portion 21 and the locking protrusion 19 is sufficient. However, both the notch portion 21 and the locking protrusion 19 may be provided in plural. For example, two pairs of the notch portions 21 and the locking protrusions 19 may be provided at a position of 0° and a position of 180° with respect to the axis of the joint portion 3.

As indicated by a white arrow in FIG. 15(b), first, the locking protrusion 19 of the vacuum tip 1C is aligned with the notch portion 21 of the attachment 8A and the vacuum tip 1C is inserted in the attachment 8A in the axial direction. After the locking protrusion 19 is inserted up to the deepest part of the portion 21a of the notch portion 21, the vacuum tip 1C is turned with respect to the attachment 8A in the circumferential direction. By turning the vacuum tip 1C, the locking protrusion 19 is inserted in the portion 21b and reaches the deepest part. In this manner, the vacuum tip 1C is completely connected to the attachment 8A. The locking protrusion 19 is locked in the portion 21b and thus prevents the vacuum tip 1C from moving in the axial direction. In this locked state, appropriate friction is preferably applied between the vacuum tip 1C and the vacuum hose 2 to prevent the vacuum tip 1C from easily turning with respect to the vacuum hose 2 in the circumferential direction.

When the vacuum tip 1C is completely connected to the attachment 8A, alignment of the light emitting faces of the three light source devices 41 of the attachment 8A with the tip-side light-receiving end faces of the optical fibers 6B₁, 6B₂, and 6B₃ of the vacuum tip 1C is completed at the same time and the vacuum tip 1C and the attachment 8A are in contact with each other. In order to realize this contact, the positions of the light source devices 41 and the positions of the optical fibers 6B₁, 6B₂, and 6B₃ are set.

Although not illustrated in the drawings, the notch portion 21 can be formed in the attachment 8A (see FIG. 11) provided with the light source devices 41 on the outer surface of the tube body. A vacuum tip combined in this case is of a type including a light-receiving end face of a light guiding element on an outer surface of a tube body.

The notch portion 21 of the attachment 8A is provided at a position where the notch portion 21 does not interfere with the light source devices provided on the attachment 8A or the optical fibers provided on the attachment 8A. Similarly, the locking protrusion 19 of the vacuum tip 1 is provided at a position where the locking protrusion 19 does not interfere with the light guiding element provided in the vacuum tip 1.

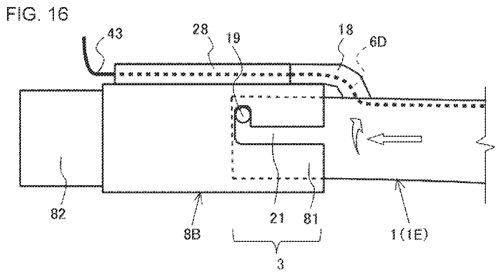

FIG. 16 illustrates another example of a combination of the attachment and the vacuum tip in an embodiment in which a locking mechanism is provided. The attachment 8B is the same as that in the embodiment illustrated in FIG. 10. The optical fiber 43 is attached to the outer surface of the tube body of the attachment 8B. The vacuum tip 1E is the same as that in the embodiment illustrated in FIG. 7(b). The tip-side optical fiber 6D is embedded in the tube wall of the vacuum tip 1E, drawn from the tube wall in the vicinity of the base end, and supported and fixed by the fiber support portion 18.

At the joint portion 3, the notch portion 21 is formed on the attachment side and the locking protrusion 19 is formed on the tip side. In this case, as indicated by a white arrow, after the vacuum tip 1E is inserted in the attachment 8B in the axial direction, the vacuum tip 1E is completely connected to the attachment 8B by turning the vacuum tip 1E in the circumferential direction. At the same time, the position of the light-outputting end face of the distal end of the optical fiber 43 on the attachment side and the position of the light-receiving end face of the base end of the tip-side optical fiber 6D are set such that the light-outputting end face and the light-receiving end face are in contact with each other.

Although not illustrated in the drawings, the notch portion 21 can be formed in the attachment 8B (see FIG. 12) with the optical fiber 43 provided on the inner surface of the tube body. A vacuum tip combined in this case includes a tube body itself serving as a light guiding element or includes a light guiding element in a tube wall.

Although not illustrated in the drawings, a notch portion may be included in the vacuum tip and a locking protrusion may be included in the attachment. In this case, the locking protrusion of the attachment protrudes from the inner surface of the tube wall toward the inner side.

### (9) Other Embodiments

The vacuum tip according to the present invention is used in the oral cavity suction device with lighting according to any one of the embodiments described above. In this case, the vacuum tip has a light guiding element. The light guiding element is provided on the outer surface or the inner surface of the tube body of the vacuum tip or in the tube wall of the vacuum tip and extends in the longitudinal direction or is constituted by the tube body itself of the vacuum tip. The light guiding element has a tip-side light-receiving end face facing the base end side of the vacuum tip and can guide light input from the tip-side light-receiving end face and project the light from the side surface extending in the longitudinal direction or from the distal end.

The vacuum hose according to the present invention is used in the oral cavity suction device with lighting according to any one of the embodiments excluding the embodiments in which the attachments described above are provided. In this case, the vacuum hose has a hose-side light-outputting end face facing the distal end side of the vacuum hose to output light from the light source.

While the present invention has been explained with reference to the drawings illustrating several embodiments of the present invention, a mode in which one or plural configurations explained in one embodiment is combined with one or plural configurations explained in another embodiment is included as an embodiment of the present invention as long as the embodiment follows the gist of the present invention. Further, as long as it follows the gist of the present invention, variously modified modes can be made and these are also included as the embodiments of the present invention.

1. An oral cavity suction device including a vacuum hose (2) connected to a suction source and a vacuum tip (1) provided with a tube body having a base end connectable to a distal end of the vacuum hose (2) and a distal end that is a suction opening (11), the oral cavity suction device comprising:
a light source device (41) being a light emitting diode or a halogen lamp that is fixed to an outer surface or an inner surface of the vacuum hose (2) in the vicinity of the distal end of the vacuum hose (2), and is supplied with power;
a hose-side light-outputting end face that is included in the vacuum hose (2) and arranged to face a distal end side of the vacuum hose (2) to output light from the light source device (41); and
a light guiding element (6) that is included in the vacuum tip (1), has a tip-side light-receiving end face arranged to face a base end side of the vacuum tip (1), and can guide light input from the tip-side light-receiving end face and project the light, wherein
the hose-side light-outputting end face and the tip-side light-receiving end face are positioned to allow light to be transmitted from the hose-side light-outputting end face to the tip-side light-receiving end face in a state in which the vacuum tip (1) is completely connected to the vacuum hose (2).

2. The oral cavity suction device with lighting according to claim 1, wherein a light emitting face (42) of the light source device (41) is the hose-side light-outputting end face.

3. The oral cavity suction device with lighting according to claim 1, further comprising:
a hose-side optical fiber (43) that has a base end connected to a light emitting face (42) of the light source device (41) and is fixed to the vacuum hose (2), wherein
a distal end face (44) of the hose-side optical fiber (43) is the hose-side light-outputting end face.

4. (canceled)

5. The oral cavity suction device with lighting according to claim 1, further comprising a tip-side optical fiber (6A, 6B) extending on an outer surface or an inner surface of a tube body of the vacuum tip (1A, 1C) or in a tube wall of the vacuum tip in a longitudinal direction, wherein
the tip-side optical fiber (6A, 6B) is the light guiding element (6), and
a base end face (63) of the tip-side optical fiber (6A, 6B) is the tip-side light-receiving end face.

6. The oral cavity suction device with lighting according to claim 1, wherein
the tube body itself of the vacuum tip (1B) forms a light guide that can guide light in a longitudinal direction by fully reflecting the light,
the tube body itself of the vacuum tip (1B) is the light guiding element (6), and
a base end face (15) of the tube body of the vacuum tip (1B) is the tip-side light-receiving end face.

7. The oral cavity suction device with lighting according to claim 1, wherein
the vacuum tip (1D) includes a tube body having a core portion (6C1) extending in a tube wall in a longitudinal direction and a cladding portion (6C2) forming a tube wall excluding the core portion (6C1),
the core portion (6C1) and the cladding portion (6C2) are branched from an outer surface of the tube body at a position near a base end of the tube body and are continuous to a core and a cladding of an input optical fiber (6C) extending toward a base end side of the vacuum tip (1D),
the tube body itself of the vacuum tip (1D) and the input optical fiber (6C) are the light guiding element (6), and
a free end (63) of the input optical fiber (6C) is the tip-side light-receiving end face.

8. The oral cavity suction device with lighting according to claim 7, wherein the core portion (6C1) spirally extends in the tube wall with an axis of the tube body serving as a spiral axis.

9. The oral cavity suction device with lighting according to claim 1, further comprising a tip-side optical fiber (6D) extending in a tube wall of the vacuum tip (1E) in a longitudinal direction, drawn from an outer surface of the tube body at a position near a base end of the tube body, and extending toward the base end side of the vacuum tip (1E), wherein
the tip-side optical fiber (6D) is the light guiding element (6), and
a base end face (63) of the tip-side optical fiber (6D) is the tip-side light-receiving end face.

10. The oral cavity suction device with lighting according to claim 1, wherein
the tube body itself of the vacuum tip (1F) forms a light guide that can guide light in a longitudinal direction by fully reflecting the light and a part of the light guide forms a branch portion (14) branched from an outer surface of the tube body at a position near a base end of the tube body and extending toward a base end side of the vacuum tip (1F),
the tube body itself of the vacuum tip (1F) and the branch portion (14) are the light guiding element (6), and
a free end (15) of the branch portion (14) is the tip-side light-receiving end face.

11. The oral cavity suction device with lighting according to claim 1, wherein
an end of the vacuum tip (1) and an end of the vacuum hose (2) are attached to each other, one of the end of the vacuum tip (1) and the end of the vacuum hose (2) is a notch portion (21) having a first portion (21a) extending from the distal end of the wall in the longitudinal direction and a second portion (21b) extending from the deepest part of the first portion (21a) in the circumferential direction, and the other of the end of the vacuum tip (1) and the end of the vacuum hose (2) is a locking protrusion (19), and
when the vacuum tip (1) is inserted in the vacuum hose (2), the vacuum tip (1) is completely connected to the vacuum hose (2) by moving the locking protrusion (19) in the first portion (21a) of the notch portion (21) in a longitudinal direction and thereafter moving the locking protrusion (19) in the second portion (21b) of the notch portion (21) in a circumferential direction at a joint portion (3) of the vacuum tip (1) and the vacuum hose (2).

12. An oral cavity suction device with lighting, comprising:
an attachment (8A) including a tube body having a base end (82) that can be inserted in a distal end of a vacuum hose (2) connected to a suction source, and a distal end (81) in which a base end (17) of a vacuum tip (1) can be inserted;
a light source device (41) fixed to an outer surface or an inner surface of the tube body of the attachment (8A), and supplied with power;
a light-outputting end face (44) fixed to the outer surface or the inner surface of the tube body of the attachment (8A) and facing a distal end side of the attachment (8A) to output light from the light source device (41);
a vacuum tip (1) including a tube body having a base end that can be inserted in the distal end of the attachment (8A) and a distal end that is a suction opening (11); and
a light guiding element (6) that is provided in the vacuum tip (1), has a light-receiving end face arranged to face a base end side of the vacuum tip (1), and can guide light input from the light-receiving end face and project the light, wherein
the light-outputting end face and the light-receiving end face are positioned to allow light to be transmitted from the light-outputting end face to the light-receiving end face in a state in which the vacuum tip (1) is completely connected to the attachment (8A).

13. (canceled)

14. The oral cavity suction device with lighting according to claim 12, wherein the light guiding element (6) is provided on an outer surface or an inner surface of the tube body of the vacuum tip (1) or in a tube wall of the vacuum tip (1) in a longitudinal direction or is constituted by a tube body itself of the vacuum tip (1).

15. The oral cavity suction device with lighting according to claim 12, wherein
an end of the vacuum tip (1) and an end of the attachment (8A, 8B) are attached to each other, one of the end of the vacuum tip (1) and the end of the attachment (8A, 8B) is a notch portion (21) having a first portion (21a) extending from the distal end of the wall in the longitudinal direction and a second portion (21b) extending from the deepest part of the first portion (21a) in the circumferential direction, and the other of the end of the vacuum tip (1) and the end of the attachment (8A, 8B) is a locking protrusion (19), and
when the vacuum tip (1) is inserted in the attachment (8A, 8B), the vacuum tip (1) is completely connected to the attachment (8A, 8B) by moving the locking protrusion (19) in the first portion (21a) of the notch portion (21) in a longitudinal direction and thereafter moving the locking protrusion (19) in the second portion (21b) of the notch portion (21) in a circumferential direction at a joint portion (3) of the vacuum tip (1) and the attachment (8A, 8B).

16. An attachment used in the oral cavity suction device with lighting according to claim 12.

17. A vacuum tip (1) used in the oral cavity suction device with lighting according to claim 1, comprising a light guiding element (6) provided on an outer surface or an inner surface of the tube body of the vacuum tip (1) or in a tube wall of the vacuum tip (1) in a longitudinal direction or constituted by the tube body itself of the vacuum tip (1), wherein
the light guiding element (6) has a light-receiving end face arranged to face a base end side of the vacuum tip (1) and can guide light input from the light-receiving end face and project the light.

18. A vacuum hose (2) used in the oral cavity suction device with lighting according to claim 1, comprising:
the light source device (41) including a light emitting diode (LED) or a halogen lamp that is fixed to an outer surface or an inner surface of the vacuum hose 2 in the vicinity of the distal end of the vacuum hose 2, and is supplied with power; and
a hose-side light-outputting end face arranged to face a distal end side of the vacuum hose (2) to output light from [[a]] the light source device (41).

19. The oral cavity suction device with lighting according to claim 1, further comprising:
a control unit (7) that is attached to the outer surface of the vacuum hose (2) in the vicinity of the light source device (41), and includes a switch that turns on and off a power supply of the light source device (41);
a housing accommodating the control unit (7); and
an operation unit of the switch provided on an outer surface of the housing.

20. The oral cavity suction device with lighting according to claim 1, wherein
a power supply of the light source device (41) is a battery or a rechargeable battery.

21. The oral cavity suction device with lighting according to claim 13, further comprising:
a control unit (7) that is attached to the outer surface of the attachment (8A) in the vicinity of the light source device (41), and includes a switch that turns on and off a power supply of the light source device (41);
a housing accommodating the control unit (7); and
an operation unit of the switch provided on an outer surface of the housing.

22. The oral cavity suction device with lighting according to claim 13, wherein
a power supply of the light source device (41) is a battery or a rechargeable battery.
